(19) United States
(12) Patent Application Publication
(10) Pub. No.: US 2026/0091371 A1
(43) Pub. Date: Apr. 2, 2026

(54) CATALYST COMPOSITE FOR HYDROGEN ISOTOPE EXCHANGE AND MANUFACTURING METHOD THEREOF

(71) Applicant: KOREA ATOMIC ENERGY RESEARCH INSTITUTE, Daejeon (KR)

(72) Inventors: ChanWoo PARK, Daejeon (KR); Dong-Yeun KOH, Daejeon (KR); Huiryung HEO, Daejeon (KR); Hyung Ju KIM, Seoul (KR); Hee-Man YANG, Daejeon (KR)

(21) Appl. No.: 19/222,054

(22) Filed: May 29, 2025

(30) Foreign Application Priority Data
Sep. 27, 2024 (KR) 10-2024-0131636

(51) Int. Cl. B01J 23/42; B01J 31/02; B01J 31/16; B01J 31/28; B01J 37/02; G21F 9/06

(52) U.S. Cl. CPC B01J 23/42; B01J 31/0238; B01J 31/1691; B01J 31/28; B01J 37/0207; B01J 37/0209; B01J 37/024; G21F 9/06

(57) ABSTRACT

The present invention relates to a catalyst composite for exchanging hydrogen isotope and a manufacturing method thereof, and more specifically, to a catalyst composite for exchanging hydrogen isotope which has hydrophobicity and prevents liquid water from covering the catalyst while at the same time not blocking water molecules from approaching the catalyst, so that the efficiency of the hydrogen isotope exchange reaction can also be secured very excellently, and at the same time, excellent reaction efficiency can be secured without relying on the hydrophobicity of a support, and thus the present invention relates to a catalyst composite for exchanging hydrogen isotope and manufacturing method thereof which is very excellent in terms of its utilization.

### CROSS-REFERENCE TO RELATED APPLICATION

This application claims priority to and the benefit of Korean Patent Application No. 10-2024-0131636, filed on Sep. 27, 2024, the disclosure of which is incorporated herein by reference in its entirety.

### TECHNICAL FIELD

The present invention relates to a catalyst composite for exchanging hydrogen isotope and a manufacturing method thereof, and more specifically, to a catalyst composite for exchanging hydrogen isotope which has hydrophobicity and prevents liquid water from covering the catalyst while at the same time not blocking water molecules from approaching the catalyst, so that the efficiency of the hydrogen isotope exchange reaction can also be secured very excellently, and at the same time, excellent reaction efficiency can be secured without relying on the hydrophobicity of a support, and thus the present invention relates to a catalyst composite for exchanging hydrogen isotope and a manufacturing method thereof which is very excellent in terms of its utilization.

### RELATED ART

A significant portion of electricity is still generated from coal, gas, and oil, which inevitably contributes to the climate crisis. Consequently, nuclear power generation has recently been gaining traction as a viable alternative. However, the tritium-containing wastewater produced in the nuclear power generation process poses severe health risks if released into the environment. Furthermore, tritium (T) and deuterium (D) serve as essential resources, not only as nuclear fusion fuel but also as critical materials for next-generation technologies such as semiconductors and organic light-emitting diodes (OLEDs). Therefore, beyond the environmental concerns, it is crucial to separate and recover these isotopes.

However, protium (H), deuterium (D), and tritium (T) exhibit highly similar chemical properties, making their separation inherently challenging. A recently reported separation method utilizes isotope exchange reactions between water and hydrogen gas to achieve efficient isotope separation. This method has garnered significant attention due to its high isotope separation efficiency and the non-toxic nature of hydrogen gas.

The isotope exchange reaction between water and hydrogen gas primarily involves metal catalysts. However, since this reaction occurs at the interface between liquid and gas, efficiency issues arise. This is because the liquid condenses in bulk form on the metal catalyst, blocking the contact between the metal catalyst and the gas, thereby inhibiting the reaction between the liquid and the gas.

To address this issue, conventional approaches have focused on macroscopic water repellency. These approaches include directly dispersing metal catalysts into hydrophobic polymer-based matrices or incorporating them into non-hydrophobic supports before further dispersion using hydrophobic polymer matrices or binders. However, such conventional methods only impart hydrophobic properties to the catalyst matrix at a macroscopic level. As a result, water still covers the catalyst, or in a microscopic environment, the infiltration of water molecules into the catalyst is completely blocked, leading to the issue that the reaction efficiency remains suboptimal.

Additionally, these conventional methods rely on the hydrophobicity of the polymers forming the matrix, thereby limiting the choice of matrices. Consequently, the inability to freely shape the catalyst composite restricts its practical applicability.

Therefore, there is a need to develop a highly efficient catalyst composite for exchanging hydrogen isotope. The composite should maintain hydrophobicity to prevent water molecules from covering the catalyst while simultaneously ensuring excellent efficiency in the hydrogen isotope exchange reaction. Moreover, it should achieve high reaction performance without relying on the hydrophobicity of the matrix, making it highly advantageous for practical applications.

### SUMMARY

The present invention has been proposed to solve the above-described problems, and the purpose of the present invention is to provide a catalyst composite for exchanging hydrogen isotope which has hydrophobicity and prevents liquid water from covering the catalyst while at the same time not blocking water molecules from approaching the catalyst, so that the efficiency of the hydrogen isotope exchange reaction can also be secured very excellently, and at the same time, excellent reaction efficiency can be secured without relying on the hydrophobicity of a support, and thus the purpose of the present invention is to provide a catalyst composite for exchanging hydrogen isotope which is very excellent in terms of its utilization and a manufacturing method thereof.

In order to solve the above-described problem,

The present invention provides a catalyst composite for exchanging hydrogen isotope comprising a catalyst support including a metal organic framework complex having an open metal site (OMS) and pores; a hydrophobically modified compound introduced into the OMS; and a metal catalyst configured to exchange hydrogen isotope, the metal catalyst being introduced into the pores.

Also, the catalyst composite for exchanging hydrogen isotope may further comprise a catalyst matrix, wherein the catalyst support may be dispersed within the catalyst matrix.

Also, the water contact angle of the metal organic framework complex may be 90° or more.

Also, the water contact angle of the metal organic framework may be 90° or more, and a water vapor diffusivity may be 5×10⁻¹⁴ cm²/s or more.

Also, the hydrophobically modified compound may include a compound represented by Chemical Formula 1 below:

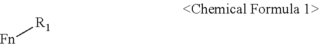

Wherein Fn includes any one of —NH₂, —NH—, —NRH, —N═, —NR₂, —C₅H₅N, —OH, —COOH, —PH₂, —PO₃²⁻ or —SH,
R1 includes any one of a C1 to C20 alkyl group, a C1 to C20 heteroalkyl group, C1 to C20 aryl group or a C1 to C20 heteroaryl group.

Also, the hydrophobically modified compound may include at least one selected from the group consisting of dodecylamine, decylamine, octylamine, hexylamine, aniline and benzylamine.

Also, the metal catalyst may include at least one selected from the group consisting of Pt, Pd, Ir, Rh, Re, Ni, Co, W, Cu, Au, Ag, Mo and Fe.

Also, the catalyst matrix may include a hydrophobic polymer matrix.

Also, the catalyst composite may further comprise a binder, wherein the catalyst support is aggregated by the binder.

In addition, in order to solve the above-mentioned problem, the present invention provides a method for manufacturing a catalyst composite for exchanging hydrogen isotope, the method comprising, preparing a metal organic framework including an open metal site (OMS) and pores; forming a hydrophobically modified metal organic framework complex by introducing a hydrophobically modified compound into the OMS of the metal organic framework; reacting the hydrophobically modified metal organic framework complex with a catalyst matrix to disperse inside the catalyst matrix, and introducing a metal catalyst for hydrogen isotope exchange between the preparing and the forming, or between the forming and reacting.

Also, the water contact angle of the hydrophobically modified metal organic framework complex may be 90° or more.

Also, the hydrophobically modified compound may include a compound represented by Chemical Formula 1 below:

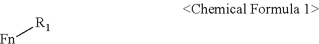

Wherein Fn includes any one of —NH₂, —NH—, —NRH, —N═, —NR₂, —C₅H₅N, —OH, —COOH, —PH₂, —PO₃²⁻ or —SH,
R1 includes any one of a C1 to C20 alkyl group, a C1 to C20 heteroalkyl group, C1 to C20 aryl group or a C1 to C20 heteroaryl group.

In addition, in order to solve the above-mentioned problem, the present invention provides a catalyst composite for hydrogen isotope exchange produced by the above-mentioned method.

Through the present invention, a catalyst composite for exchanging hydrogen isotope can be provided which has excellent usability as it prevents liquid water from covering the catalyst due to hydrophobicity while at the same time not blocking water molecules from approaching the catalyst, thereby ensuring excellent efficiency of the hydrogen isotope exchange reaction, and at the same time, secures excellent reaction efficiency without relying on the hydrophobicity of the matrix.

### BRIEF DESCRIPTION OF THE DRAWINGS

FIG. 1 is a schematic diagram showing the manufacturing process of a catalyst composite for exchanging hydrogen isotope according to a preferred embodiment of the present invention.

FIG. 2 is a schematic diagram roughly showing a hydrogen isotope exchange reactor.

FIG. 3 shows the results of XRD (X-ray diffraction) analysis performed on Example 1, Comparative Example 1, Comparative Example 2, and Example 2 of the present invention.

FIG. 4 shows the adsorption curves after performing an N₂ adsorption experiment on Comparative Example 1 and Comparative Example 2 of the present invention.

FIG. 5 shows the results of measuring the pore size distribution through non-local density functional theory based on FIG. 4, which is the N₂ adsorption curve for Comparative Example 1 and Comparative Example 2 of the present invention.

FIG. 6 shows the results of FT-IR analysis performed on Example 1 and Comparative Examples 1 to 2 of the present invention.

FIG. 7 shows the shape of the nanocrystals of Example 1, Comparative Example 1, Comparative Example 3, and Example 2 of the present invention, taken using a scanning electron microscope (SEM).

FIG. 8 shows the results of high-angle annular dark-field imaging analysis performed using HAADF-STEM for Example 2 of the present invention.

FIG. 9 shows the results of mapping Pt using EDS analysis for Example 2 of the present invention.

FIG. 10 shows the results of mapping Cr, C, O, and N using EDS analysis for Example 2 of the present invention.

FIG. 11 is a TEM (transmission electron microscope) photograph of Example 2 of the present invention.

FIG. 12 is a TEM (transmission electron microscope) photograph of Example 2 of the present invention at a magnification of 10 times that of FIG. 11.

FIG. 13 is a XPS (X-ray electron spectroscopy) analysis performed to analyze the oxidation state of platinum contained in each of Comparative Example 3 which did not perform a platinum reduction step, Comparative Example 3, and Example 2, in the present invention, and the results are shown.

FIG. 14 is a XANES (X-ray absorption near edge structure) analysis performed on Example 2 of the present invention, and the results are shown by comparing the results with those of Pt foil, PtO₂, and H₂PtCl₆ (precursor of a platinum catalyst).

FIG. 15 shows the results of EXAFS (Extended X-ray absorption fine structure) analysis performed on Example 2 of the present invention, and comparing the results with those of Pt foil and PtO₂.

FIG. 16 shows the results of obtaining water vapor adsorption isotherms for Comparative Example 1, Comparative Example 3, and Example 2 to measure water repellency after the introduction of a hydrophobically modified compound in the present invention.

FIG. 17 shows the results of evaluating water vapor diffusivity for Comparative Example 1 and Comparative Example 2 to measure the change in the degree to which water molecules contact the catalyst due to the introduction of a hydrophobically modified compound in the present invention.

FIG. 18 shows the experimental results of Comparative Example 1 and Comparative Example 2 of the present invention under conditions of 25° C. and 90% relative humidity, where the x-axis represents s^{1/2} and the y-axis represents the ratio of the amount of water vapor adsorption over time to the maximum amount of water vapor adsorption. The results were then fitted using the Fickian diffusion model for each case.

FIG. 19 shows photographs of the water contact angles evaluated for Example 1, Comparative Examples 1, Comparative Examples 2, and Example 2 of the present invention.

FIG. 20 shows the results of evaluating the macroscopic water repellency of Pt@MIL-101/PVDF, which was prepared by dispersing Example 1 and Comparative Examples 3 of the present invention in PVDF in the same manner as Example 1, by immersing it in deionized water for 5 seconds.

FIG. 21 shows the results of measuring the column efficiency over time for Example 1 of the present invention.

FIG. 22A shows the results of comparing the column efficiency over temperature for Pt@MIL-101/PVDF manufactured by dispersing Example 1 and Comparative Example 3 in PVDF in the same manner as Example 1.

FIG. 22B shows the results of comparing the column efficiency over G/L for Pt@MIL-101/PVDF manufactured by dispersing Example 1 and Comparative Example 3 in PVDF in the same manner as Example 1.

FIG. 22C shows the ratio of column efficiency measured after performing a reaction for 28 days for Example 1 of the present invention, compared to the column efficiency value on the first day.

FIG. 23A shows the results of In situ DRIFTs (In-situ Diffuse Reflectance Infrared Fourier Transform Spectroscopy) analysis performed on MIL-101-12/PVDF manufactured by dispersing Example 1, Comparative Example 1, and Comparative Example 2 of the present invention in PVDF in the same manner as Example 1, and Pt@MIL-101/PVDF manufactured by dispersing Comparative Example 3 in PVDF in the same manner as Example 1.

FIG. 23B shows an enlarged view of the region where a bond with H₂O is formed in the In situ DRIFTs spectrum of Example 1 of the present invention.

FIG. 23C shows an enlarged view of the region where a bond with D₂O is formed in the In situ DRIFTs spectrum of Example 1 of the present invention.

FIG. 23D shows the results of In situ DRIFTs spectrum of Comparative Example 1 of the present invention and Pt@MIL-101/PVDF.

FIG. 24 is a schematic diagram showing the behavior of H₂O molecules and D₂O molecules for Example 1 of the present invention.

FIG. 25 is an In situ DRIFTs spectrum result of MIL-101-12/PVDF of the present invention.

FIG. 26 is an SEM image taken after irradiating Example 1 of the present invention with radiation.

FIG. 27 is an FT-IR analysis result taken after irradiating Example 1 and Comparative Example 2 of the present invention with radiation.

FIG. 28 is an XRD analysis result taken after irradiating Example 1 and Comparative Example 2 of the present invention with radiation.

FIG. 29 is an XPS analysis result taken after irradiating Example 1 and Comparative Example 2 of the present invention with radiation.

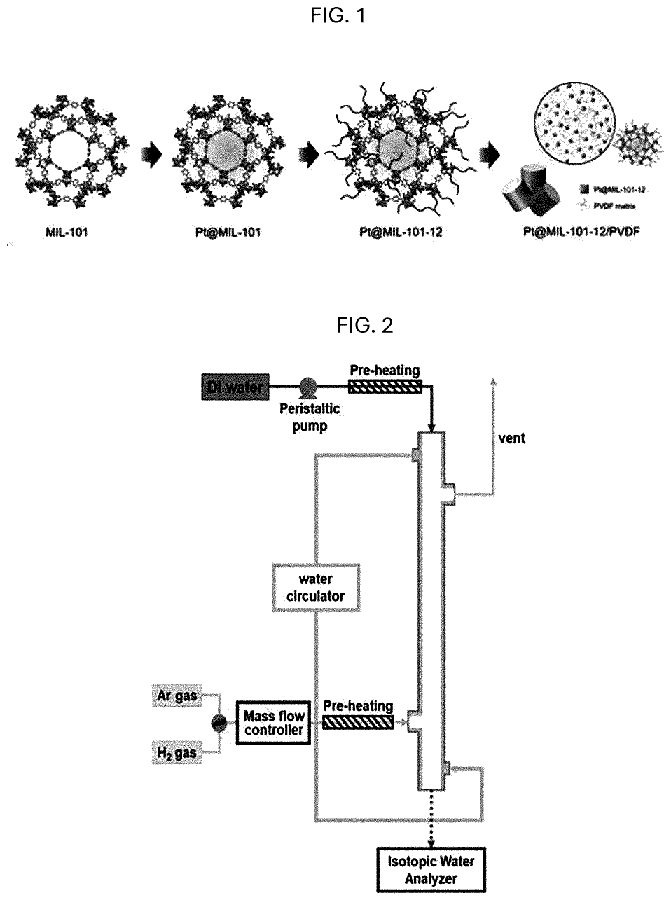

### DETAILED DESCRIPTION OF THE EMBODIMENTS

Hereinafter, examples of the present invention will be described in detail so that those with ordinary skill in the art can easily implement the present invention. The present invention may be implemented in various different forms and is not limited to the examples described herein.

As described above, conventional catalyst composites for exchanging hydrogen isotope depend only on the matrix of the catalyst for their hydrophobicity. Therefore, even if hydrophobicity is introduced through the matrix, liquid water still covers the surface of the catalyst or the inflow of water molecules into the catalyst is blocked at the source, resulting in poor reaction efficiency. In addition, since the hydrophobicity depends on the hydrophobicity of the matrix, the choice of the matrix is limited, which is very disadvantageous in terms of utilization.

Accordingly, the present invention seeks to solve the above-described problem by providing a catalyst composite for exchanging hydrogen isotope, the catalyst composite comprising a catalyst support including a metal organic framework complex having an open metal site (OMS) and pores; a hydrophobically modified compound introduced into the OMS; and a metal catalyst configured to exchange hydrogen isotope, the metal catalyst being introduced into the pores.

Through this, compared to conventional catalyst composites for exchanging hydrogen isotope, a hydrogen isotope exchange reaction can occur smoothly while preventing liquid water from covering the catalyst, so that a catalyst composite with excellent reaction efficiency is provided while not depending on the hydrophobicity of the matrix, and thus is excellent in terms of its usability.

First, the catalyst composite for exchanging hydrogen isotope according to the present invention comprises a catalyst support including a metal organic framework complex having an open metal site (OMS) and pores.

More specifically, the metal organic framework complex comprises a metal-organic framework (MOF). Here, the metal-organic framework refers to a porous material in which a metal cluster and an organic linker (or organic bridging ligand) are connected by a coordination bond to form a three-dimensional structure, and various metal-organic frameworks can be formed depending on the selection of the metal ion and the organic ligand. This metal-organic framework has pores inside, and the size of these pores can be controlled by changing the type of organic linker or metal cluster, so that it is very useful compared to other porous materials, and its performance of supporting a catalyst inside is also very excellent. In addition, since the metal-organic framework has a very large specific surface area, it enables a very high reaction efficiency to be achieved compared to other porous materials when a catalyst is introduced inside. In addition, since it has a hard skeleton itself, it has very excellent chemical stability and thermal stability.

As these metal-organic frameworks are included in the catalyst composite for exchanging hydrogen isotope, the reaction efficiency can be very superior compared to cases when other porous materials are introduced, and also, as the chemical stability is excellent, it can operate stably even in a radioactive environment exposed to tritium, and also, as the pore size is appropriately controlled, it is excellent in that it can prevent the loss of the catalyst and cause the hydrogen isotope exchange reaction stably for a long period of time.

More specifically, the metal-organic framework may be used without limitation provided that it can be applied to a catalyst composite for hydrogen isotope exchange, but for example, the metal cluster may include at least one metal selected from the group consisting of Ti, Zr, Hf, V, Nb, Ta, Cr, Mo, W, Mn, Re, Fe, Ru, Os, Co, Rh, Ir, Ni, Pd, Pt, Cu, Ag, Au, Zn, Cd, Hg, Mg, Ca, Sr, Ba, Sc, Y, Al, Ga, In, TI, Si, Ge, Sn, Pb, As, Sb, Bi, Ce, La, and preferably, at least one metal selected from the group consisting of chromium, vanadium, iron, nickel, cobalt, copper, zinc, titanium, and manganese. In addition, not only the metal itself but also any compound of the metal may be used without limitation as the metal source.

In addition, in the case of the organic linker of the metal-organic framework, any organic substance having a functional group that can be coordinated is possible, and the functional group that can be coordinated may be exemplified by a carboxylic acid group, a carboxylic acid anion group, an amino group (—NH₂), an imino group (═NH₂), an amide group (—CONH₂), a sulfonic acid group (—SO₃H), a sulfonic acid anion group (—SO₃⁻), a methanedithioic acid group (—CS₂H), a methanedithioic acid anion group (—CS₂⁻), a pyridine group, or a pyrazine group. In order to induce a more stable metal-organic framework, an organic substance having two or more coordination sites, for example, a bidentate or tridentate, may be advantageous. As for organic substances, if there is a coordination site, neutral organic substances such as bipyridine and pyrazine, anionic organic substances such as carboxylic acid anions such as terephthalate, naphthalenedicarboxylate, benzenetricarboxylate, glutarate, and succinate, as well as cationic substances are possible. In the case of the carboxylic acid anion, in addition to those having an aromatic ring such as terephthalate, it can also be an anion of a linear carboxylic acid such as formate, and an anion having a non-aromatic ring such as cyclohexyldicarbonate. Not only organic substances that have a coordination site, but also those that have a potential coordination site and can be changed to be coordinated under reaction conditions are possible. That is, even if an organic acid such as terephthalic acid is used, it can bind to a metal component as terephthalate after the reaction. Representative examples of organic substances that can be used include organic acids and their anions selected from benzenedicarboxylic acid, naphthalenedicarboxylic acid, benzenetricarboxylic acid, naphthalenetricarboxylic acid, pyridinedicarboxylic acid, bipyridyldicarboxylic acid, formic acid, oxalic acid, malonic acid, succinic acid, glutaric acid, hexanedioic acid, heptanedioic acid, or cyclohexyldicarboxylic acid, pyrazine, bipyridine, etc. In addition, one or more organic substances can be mixed and used.

The metal-organic framework may be at least one selected from the group consisting of, for example, MIL-101, HKUST-1, MOF-74, MOF-808, PCN-222, MIL-125, MIL-53, and MOF-5, and preferably at least one selected from the group consisting of MIL-101, HKUST-1, and MOF-74. At this time, when the metal-organic framework is at least one selected from the group consisting of MIL-101, HKUST-1, and MOF-74, the metal-organic framework can be synthesized in large quantities, and it is very advantageous in that it is easy to introduce the compound into OMS, so that its usability is excellent.

More specifically, the metal-organic framework included in the catalyst composite for exchanging hydrogen isotope according to the present invention has pores. The metal catalyst for hydrogen isotope exchange, which will be described later, can be supported in the pores. At this time, the average size of the pores is not particularly limited, but is preferably 0.5 to 20 nm. At this time, if the size of the pores is less than 0.5 nm, the diffusion of the material is not easy, making it difficult for the catalyst and the reactant to come into contact, which may be disadvantageous in terms of reaction efficiency. In addition, if the average size of the pores exceeds 20 nm, the specific surface area may decrease as the pores become too large, which may be disadvantageous in terms of reaction efficiency, and the problem of the catalyst being easily desorbed may also occur.

In addition, the size of the pores may be appropriately adjusted according to the type of the catalyst and the reaction environment, and at this time, in order to adjust the size of the pores, the type of the metal-organic framework may be appropriately selected, or more specifically, the composition of the metal clusters and organic linkers forming the metal-organic framework may be appropriately selected.

More specifically, a metal catalyst for hydrogen isotope exchange may be introduced into the pores described above. The metal catalyst for hydrogen isotope exchange acts as a catalyst for the hydrogen isotope exchange reaction between water and hydrogen gas. At this time, the following reaction formula 1 represents a reaction formula for an isotope exchange reaction between water and hydrogen gas. At this time, I is at least one selected from the group consisting of deuterium (D) or tritium (T).

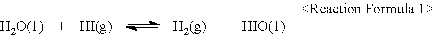

More specifically, the type of the catalyst is not limited, provided that it can act as a catalyst for the hydrogen isotope exchange reaction between water and hydrogen gas, but more specifically, it may include at least one selected from the group consisting of Pt, Pd, Ir, Rh, Re, Ni, Co, W, Cu, Au, Ag, Mo, Fe, and the group consisting of oxides or sulfides thereof, and may also include an alloy including at least one selected from the group consisting of Pt, Pd, Ir, Rh, Re, Ni, Co, W, Cu, Au, Ag, Mo, Fe. At this time, preferably, the metal catalyst for hydrogen isotope exchange may be at least one selected from the group consisting of Pt, Pd, Ni, and Au. When the metal catalyst is at least one selected from the group consisting of Pt, Pd, Ni, and Au, it may be advantageous in that the catalytic efficiency for the hydrogen isotope exchange reaction is very excellent.

More specifically, the metal catalyst for hydrogen isotope exchange may have an average diameter of 0.5 to 5 nm. At this time, if the average diameter of the metal catalyst for hydrogen isotope exchange is less than 0.5 nm, the stability of the catalyst may decrease, causing side reactions such as aggregation, which may be disadvantageous in terms of maintaining the catalytic performance. In addition, if the average diameter exceeds 5 nm, the specific surface area of the catalyst may decrease, which may be disadvantageous in terms of reaction efficiency, since the ratio of atoms actually in contact with the reactant may decrease.

More specifically, the metal catalyst for hydrogen isotope exchange may be added at 0.5 to 30 wt % to the metal-organic framework. At this time, if the metal catalyst for hydrogen isotope exchange is included at less than 0.5 wt %, the hydrogen isotope reaction may not be performed smoothly due to the small amount of catalyst, and in order to secure the absolute amount of the metal catalyst for hydrogen isotope exchange within the catalyst composite for exchanging hydrogen isotope, a large amount of the metal-organic framework complex must be used, which may be disadvantageous in terms of economics. In addition, if the metal catalyst for hydrogen isotope exchange is included in an amount exceeding 30 wt %, the pore structure of the metal-organic framework may be blocked or the specific surface area may decrease, resulting in a problem of deterioration in catalytic performance.

More specifically, the metal-organic framework included in the catalyst composite for exchanging hydrogen isotope according to the present invention has an open metal site (OMS). OMS refers to a site in a metal cluster, particularly, a position adjacent to a metal in a metal cluster formed by removing a ligand or other chemical small substance, and various types of compounds can be attached to the metal cluster or the metal inside the metal cluster through the OMS, and thus the properties of the metal-organic framework can be controlled.

In the case of the metal-organic framework, an OMS that has already been formed can be used, and an OMS can also be formed artificially and used. At this time, any method that can form an OMS in a metal-organic framework can be used without limitation, but for example, it can be formed by heat treatment to remove water or a solvent component included in the metal-organic framework.

At this time, since OMS can control the properties of the metal-organic framework by attaching any compound having a functional group that can be bonded to OMS without limitation, when using a metal-organic framework in which OMS exists, the property control is easy, which can be very advantageous in terms of utilization. In addition, if it is a compound having a functional group that can be bonded to OMS, for example, the compound to be attached can be introduced to the OMS by a simple method of mixing the metal-organic framework and heating it, so that the introduction of the compound is simple. The metal-organic framework having OMS can control its properties by introducing the compound through such a simple process, which is very excellent compared to other porous compounds such as silica or porous carbon compounds, in which the property control is achieved through a very complex process and the range is also limited.

More specifically, a hydrophobically modified compound can be introduced into the OMS. At this time, the hydrophobically modified compound is a compound having a hydrophobic portion, and as the compound is introduced into the OMS, the properties of the metal organic framework can be controlled to be hydrophobic.

Conventionally, as a means for increasing the reaction efficiency in the hydrogen isotope exchange reaction, a method of simply dispersing a metal catalyst for hydrogen isotope exchange in a hydrophobic polymer was used. However, this only secures water repellency or hydrophobicity in a macroscopic unit, so in a microscopic atmosphere, liquid water is still condensed around the catalyst, blocking contact with gas, which is disadvantageous in terms of reaction efficiency, or the access of water molecules is completely blocked, which is also disadvantageous in terms of reaction efficiency.

Therefore, the present invention solves the above-mentioned problems by introducing a hydrophobically modified compound into the OMS and controlling the properties of the metal organic framework itself to be hydrophobic. More specifically, the metal organic framework can catalyze the isotope exchange reaction between water and hydrogen gas by supporting a metal catalyst for hydrogen isotope exchange in its internal pores. Accordingly, the hydrogen isotope exchange reaction between water and hydrogen gas, which occurs as in the above-described Reaction Formula 1, can occur more specifically by the following Reaction Formulas 2 and 3. Here, I is at least one selected from the group consisting of deuterium (D) or tritium (T).

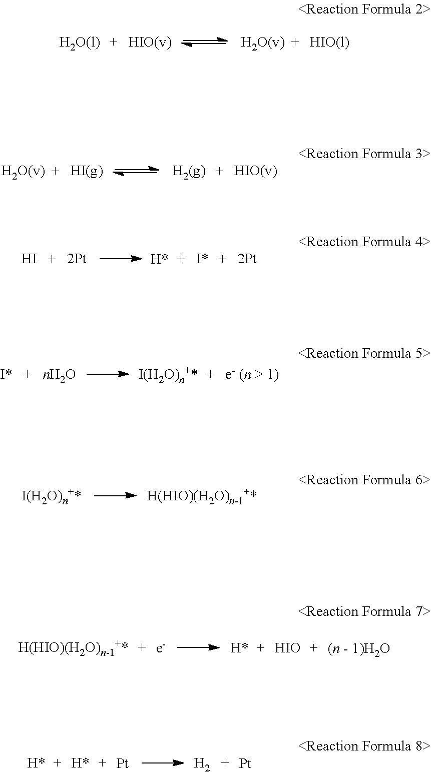

The Reaction Formula 2 represents the vapor-liquid equilibrium equation between water and water vapor, and Reaction Formula 3 represents the hydrogen isotope exchange reaction between water vapor and hydrogen gas. In addition, Reaction Formulas 4 to 8 represent the isotope exchange reaction between hydrogen and water molecules through the catalyst, for example, when the catalyst is platinum. As described above, the isotope exchange reaction between water and hydrogen gas is substantially a reaction in which water in a water vapor state meets and reacts. Therefore, in order for the hydrogen isotope exchange reaction to occur easily, the hydrophobicity of the catalyst should prevent H₂O(1) from accumulating on the surface of the catalyst, so that the catalyst and hydrogen gas can easily contact each other, while at the same time, the water vapor gas and the catalyst can contact each other, so that the hydrogen gas and the water vapor gas can easily contact each other.

Therefore, in the case where only macroscopic hydrophobicity is secured as in the conventional art, the two characteristics described above cannot be achieved at the same time, and the reaction efficiency is not excellent. In contrast, in the case of the catalyst for exchanging hydrogen isotope according to the present invention, a hydrophobically modified compound is introduced into the metal organic framework that supports the catalyst inside the pores, thereby controlling the physical properties to be hydrophobic, thereby preventing direct contact of bulk liquid water molecules with the catalyst, while at the same time, due to the pores inside, water vapor can very smoothly contact the catalyst, so that the efficiency of the hydrogen isotope exchange reaction can be much higher than conventional art.

According to a preferred embodiment of the present invention, the water contact angle of the metal organic framework complex is 90° or more. When the water contact angle of the metal organic framework complex is 90° or more, contact of liquid water with the catalyst can be effectively blocked, thereby preventing the liquid from covering the catalyst surface and blocking contact between the catalyst and hydrogen gas, while at the same time, water vapor can easily diffuse into the metal organic framework and contact the catalyst, so that the efficiency of the hydrogen isotope exchange reaction can be much higher than before. At this time, the water contact angle can be measured, for example, by dropping a water droplet on the metal organic framework complex and then measuring the contact angle at the point where the water droplet and the metal organic framework complex come into contact.

At this time, more preferably, the water contact angle metal organic framework complex may be 90′ or more, and an average water vapor diffusivity may be 5×10⁻¹⁴ cm²/s or more. When the water contact angle is 90° or more and the average water vapor diffusivity is 5×10⁻¹⁴ cm²/s or more, the above-described effect of preventing the liquid water from contacting the catalyst and allowing water vapor to easily diffuse into the metal organic framework is maximized, so that the efficiency of the hydrogen isotope exchange reaction can be significantly higher than conventional art.

At this time, the average water vapor diffusivity is calculated at a relative humidity of 0 to 100%. At this time, the water vapor diffusivity (Di) at each relative humidity can be calculated after evaluating a time-dependent adsorption isotherm at each relative humidity, and then fitting the adsorption isotherm according to the Fickian diffusion model expressed by the following Mathematical Equation 1. The time-dependent adsorption isotherm can be plotted as the ratio of the amount of water vapor adsorption per hour to the maximum amount of water vapor adsorption at each relative humidity, with t^{1/2}(s^{1/2}) as the x-axis.

$$\frac{{M}_{t}}{{M}_{∞}} = \text{} 1 - \text{} \frac{3 D}{β {a}^{2}} exp \text{} ( - β t ) \text{} \{ 1 - {( \frac{β a}{D} )}^{\frac{1}{2}} cot {( \frac{β {a}^{2}}{D} )}^{\frac{1}{2}} \} + \text{} \frac{6 β {a}^{2}}{{π}^{2} D} \text{} {{\sum }^{∞}}_{n = 1} \frac{exp ( - \frac{{Dn}^{2} {π}^{2} t}{{a}^{2}} )}{{n}^{2} ( {n}^{2} {π}^{2} - \frac{β {a}^{2}}{D} )} \qquad 〈 Mathematical Equation 1 〉$$

$${D}_{i} = water vapor diffusivity$$

$${M}_{t} = total amount of solute at a specific time t$$

$${M}_{∞} = total amount of solute at infinite time ( t {=}^{∞} )$$

$$β = parameter representing the adsorption and desorption rate of solute .$$

$$a = pore radius$$

At this time, the average water vapor diffusivity can be calculated by measuring the water vapor diffusivity for each of at least 5 arbitrarily selected relative humidity values and calculating the average.

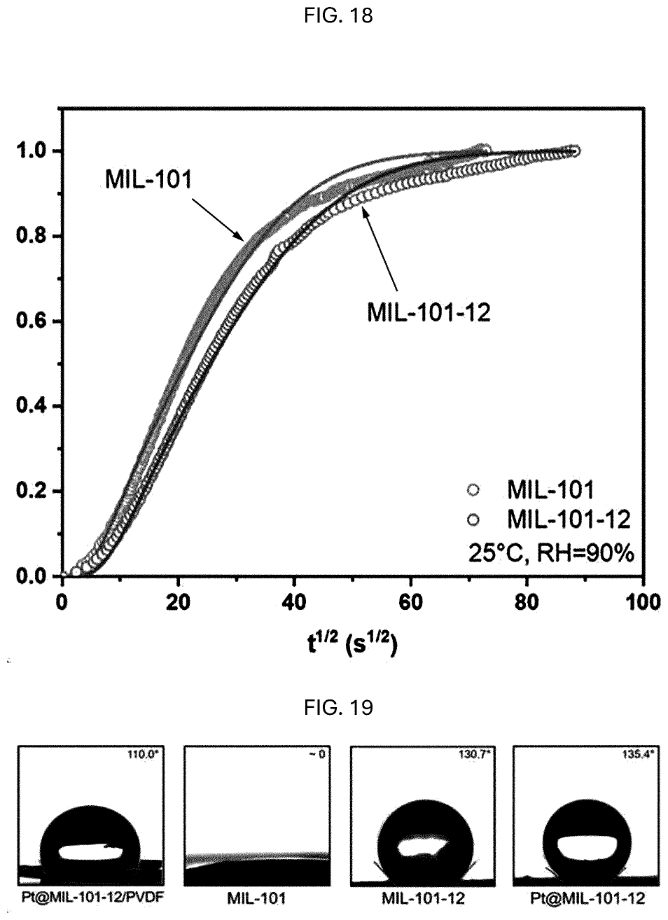

More specifically, it is explained with reference to FIG. 18. FIG. 18 shows the experimental results of the water vapor adsorption isotherm at 25° C. and 90% relative humidity, with the x-axis as s^{1/2} and the y-axis as the ratio of the water vapor adsorption amount by time to the maximum water vapor adsorption amount, and then fitting each result according to the Fickian diffusion model of the above Mathematical Equation 1. As can be seen in FIG. 18, when the time-dependent water vapor adsorption isotherm is fitted, it matches well with the Fickian diffusion model, so it can be said that it is reasonable to measure the water vapor diffusivity using the model. Therefore, after performing the fitting as described above, by measuring the Di value, the water vapor diffusivity can be measured for the corresponding relative humidity, and accordingly, by repeating the same operation at various relative humidity, the average water vapor diffusivity can be measured.

More specifically, the hydrophobically modified compound is a compound capable of controlling the properties of the metal organic framework to be hydrophobic, and may be a compound having a hydrophobic portion. The method of introducing the hydrophobically modified compound into the OMS is not limited, provided that it involves incorporating the compound into the OMS of a metal organic framework by conventional means. For example, the compound may be introduced into the OMS through covalent bonding or coordination bonding. To achieve this, the hydrophobically modified compound can be introduced by mixing it with the metal organic framework having an OMS and subjecting the mixture to a heating process.

More specifically, the hydrophobically modified compound may include a compound represented by Chemical Formula 1 below.

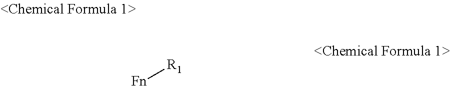

Wherein Fn includes any one of —NH₂, —NH—, —NRH, —N═, —NR₂, —C₅H₅N, —OH, —COOH, —PH₂, —PO₃²⁻ or—SH,

R1 includes any one of a C1 to C20 alkyl group, a C1 to C20 heteroalkyl group, C1 to C20 aryl group or a C to C20 heteroaryl group.

More specifically, the hydrophobically modified compound can be bonded to the OMS of the metal organic framework via the functional group (Fn).

In addition, the “alkyl group (R)” is understood to mean a straight-chain, branched-chain, or cyclic hydrocarbon group having 1 to 20 carbon atoms in particular. Examples of the alkyl group include methyl, ethyl, propyl, isopropyl, butyl, isobutyl, sec-butyl, tert-butyl, pentyl, neopentyl, hexyl, cyclopropyl, cyclobutyl, cyclopentyl, and cyclohexyl. The Cn alkyl group means an alkyl group having n carbon atoms in the hydrocarbon chain, which is the middle chain of the alkyl group, and which may be substituted or unsubstituted.

In addition, “heteroalkyl group” means an alkyl group containing 1 to 4 heteroatoms selected from nitrogen (N), oxygen (O), and sulfur(S), wherein the nitrogen and sulfur atoms are oxidized as needed, and the nitrogen atom(s) are quaternized as needed. The heteroalkyl group may be bonded to the remainder of the molecule via carbon or a heteroatom. In addition, a Cn heteroalkyl group means a heteroalkyl group having n carbon atoms in the hydrocarbon chain that is the middle chain of the heteroalkyl group, which may be substituted or unsubstituted.

In addition, an “aryl group” means a polyunsaturated, aromatic, hydrocarbon substituent that may be a single ring or multiple rings that are fused or covalently bonded together. In addition, a Cn aryl group means an aryl group having n carbon atoms in the hydrocarbon ring that is the middle chain of the aryl group, which may be substituted or unsubstituted.

In addition, “heteroaryl group” means an aryl group (or ring) containing 1 to 4 heteroatoms selected from nitrogen (N), oxygen (O), and sulfur(S) (in each separate ring in the case of multiple rings), wherein the nitrogen and sulfur atoms are oxidized as needed, and the nitrogen atom(s) are quaternized as needed. The heteroaryl group may be bonded to the remainder of the molecule through carbon or a heteroatom. In addition, a Cn heteroaryl group means a heteroaryl group having n carbon atoms in the hydrocarbon ring that is the middle chain of the heteroaryl group, which may be substituted or unsubstituted.

In addition, “substituted” in the expression “substituted or unsubstituted” means that one or more hydrogen atoms in the hydrocarbon are each, independently of one another, replaced by the same or different substituent. Useful substituents include, but are not limited to, the following.

These substituents may be at least one selected from —F; —Cl; —Br; —CN; —NO₂; —OH; a C1˜C20 alkyl group unsubstituted or substituted with —F, —Cl, —Br, —CN, —NO₂ or —OH; a C1˜C20 alkoxy group unsubstituted or substituted with —F, —Cl, —Br, —CN, —NO₂ or —OH; a C6˜C30 aryl group unsubstituted or substituted with a C1˜C20 alkyl group, a C1˜C20 alkoxy group, —F, —Cl, —Br, —CN, —NO₂ or —OH; a C6˜C30 heteroaryl group unsubstituted or substituted with a C1˜C20 alkyl group, a C1˜C20 alkoxy group, —F, —Cl, —Br, —CN, —NO₂ or —OH; C5˜C20 cycloalkyl group substituted or unsubstituted with —F, —Cl, —Br, —CN, —NO₂ or —OH; a C5˜C30 heterocycloalkyl group substituted or unsubstituted with a C1˜C20 alkyl group, a C1˜C20 alkoxy group, —F, —Cl, —Br, —CN, —NO₂ or —OH; and a group represented by —N(G1)(G2). At this time, the G1 and G2 may each independently be hydrogen; a C1˜C10 alkyl group; or a C6˜C30 aryl group substituted or unsubstituted with a C1˜C10 alkyl group.

More specifically, the R1 may have hydrophobicity. When R1 is hydrophobic, the properties of the metal organic framework complex can be controlled to be hydrophobic by introducing a hydrophobically modified compound into the OMS, and accordingly, microscopic hydrophobicity is introduced into the catalyst composite for exchanging hydrogen isotope, thereby preventing liquid water from covering the catalyst, which is disadvantageous for catalytic efficiency, while not blocking the diffusion of water molecules, so that excellent reaction efficiency can be achieved.

At this time, according to a preferred embodiment of the present invention, the hydrophobic modified compound may include at least one selected from the group consisting of dodecylamine, decylamine, octylamine, hexylamine, aniline, and benzylamine, and in this case, it may be particularly excellent in terms of improving the efficiency of the hydrogen isotope exchange reaction.

In addition, more specifically, the hydrophobically modified compound can bind to 40 to 95% of the OMS of the metal organic framework. At this time, if the hydrophobically modified compound binds to more than 95% of the OMS, it is not easy for water molecules to approach the metal catalyst, so the efficiency of the hydrogen isotope exchange reaction may decrease. In addition, if the hydrophobically modified compound binds to less than 40% of the OMS, liquid water may cover the surface of the catalyst, so the efficiency of the hydrogen isotope exchange reaction may decrease.

According to a preferred embodiment of the present invention, the catalyst composite for exchanging hydrogen isotope according to the present invention may further include a catalyst matrix, and the catalyst support may be dispersed inside the catalyst matrix.

More specifically, the catalyst matrix is not limited, provided that it can support and disperse the metal organic framework complex as a catalyst matrix of the catalyst composite for exchanging hydrogen isotope. In addition, an appropriate composition may be selected without limitation so that it can be formed or composed according to the form required for its use. This is because, in the catalyst for exchanging hydrogen isotope of the present invention, hydrophobicity is introduced into the metal organic framework complex itself, so that excellent reaction efficiency can be secured regardless of the composition or form of the catalyst matrix.

At this time, for example, the catalyst matrix may be at least one selected from the group consisting of a polymer matrix, graphene, carbon nanotubes, and carbon nitride, preferably a hydrophobic polymer matrix, and more preferably at least one selected from the group consisting of polystyrene, polyvinylidene fluoride (PVDF), polyether ether keton, polypropylene, polytetrafluoroethylene, polyethylene, polymethylmethacrylate, polychlorotrifluoroethylene, and polydimethylsiloxane. When the catalyst matrix is a hydrophobic polymer matrix, it may be excellent in terms of the efficiency of the hydrogen isotope exchange reaction, and in particular, when the catalyst matrix is at least one selected from the group consisting of polystyrene, polyvinylidene fluoride (PVDF), and polypropylene, it may be very advantageous in that the hydrogen isotope exchange reaction efficiency is excellent and processing is easy.

In addition, more specifically, the catalyst composite for exchanging hydrogen isotope may comprise 0.01 to 5 wt % of the metal organic framework complex based on its total weight. In this case, if the metal organic framework complex is contained in an amount less than 0.01 wt %, the absolute amount of the catalyst is insufficient, which may be disadvantageous in terms of the reaction efficiency of the hydrogen isotope exchange reaction. In addition, if the metal organic framework complex is contained in an amount exceeding 5 wt %, the amount of metal organic framework used is large, making it difficult to control the properties of the catalyst composite and may be disadvantageous in terms of economy.

In addition, more specifically, the catalyst matrix may be porous and have pores therein, and thus, the metal organic framework complex described below may be dispersed in the pores. More specifically, the average diameter of the pores of the catalyst matrix may be in a range of 0.002 μm to 10 μm. At this time, if the average diameter of the pores is less than 0.002 μm, the material movement inside the catalyst matrix is not smooth, which may be disadvantageous in terms of the hydrogen isotope exchange reaction efficiency. In addition, if the average diameter of the pores exceeds 10 μm, a problem may occur in which the metal organic framework complex described below is not stably supported.

In addition, more specifically, the form of the metal organic framework complex is not limited, provided that it is a conventional metal-organic framework form, but it may preferably be in the form of a powder, and more preferably, it may be in the form of a powder having an average diameter in the range of 1 nm to 0.1 mm. At this time, if the average diameter of the powder is less than 1 nm, it may be difficult to disperse inside the catalyst matrix and agglomeration may easily occur, which may cause problems in that it is difficult to handle. In addition, if the average diameter of the powder exceeds 0.1 mm, it is difficult to uniformly disperse inside the catalyst matrix, and the specific surface area decreases, which may be disadvantageous in terms of the hydrogen isotope exchange reaction efficiency.

According to a preferred embodiment of the present invention, the catalyst composite for exchanging hydrogen isotope may further include a binder, and the catalyst support may be aggregated by the binder.

In the case of conventional catalysts for exchanging hydrogen isotope, since the hydrophobicity depends only on the matrix, if the hydrophobic matrix does not exist, the efficiency as a catalyst is greatly reduced. In addition, even if it exists together with the hydrophobic matrix, there was a problem that only macroscopic hydrophobicity was secured, and the catalytic efficiency was still not excellent. Accordingly, the present invention introduces hydrophobicity to the catalyst support itself, so that not only macroscopic but also microscopic hydrophobicity or water repellency is secured, and even if the hydrophobic matrix does not exist, it can be very excellent in terms of the efficiency of the hydrogen isotope exchange reaction.

Accordingly, the catalyst composite for exchanging hydrogen isotope according to the present invention may be in the form in which the catalyst support is aggregated by the binder. More specifically, the binder is not particularly limited to a type of compound that can assemble the catalyst support to a degree that the hydrogen isotope exchange catalyst composite can be used as a catalyst in a specific hydrogen isotope exchange reaction, but preferably, it may be at least one selected from the group consisting of ethyl cellulose, polytetrafluoroethylene, polypropylene, and polystyrene.

More specifically, the catalyst composite for exchanging hydrogen isotope may include a binder in an amount of more than 0 wt % and less than or equal to 20 wt %.

In addition, more specifically, the method of aggregating the catalyst support using the binder is not limited, provided that it can be normally used to assemble the catalyst support using the binder, for example, it can be a method of mixing the catalyst support and the binder and then heating and pressing them, or a method of mixing the catalyst support binder and the solvent and then drying the solvent. At this time, it is not limited to anything that can be used when assembling the catalyst support and the binder, but for example, it can be at least one selected from water and alcohol.

In addition, more specifically, the catalyst composite for exchanging hydrogen isotope according to the present invention is not limited in its form provided that it conforms to the conventional forms that a catalyst composite for exchanging hydrogen isotope can have. For example, it may take shapes such as spherical or cylindrical. Likewise, its size is not restricted, provided that it falls within the conventional size range, and for example, its major axis may range from 1 to 10 mm.

In addition, the present invention provides a method for manufacturing a catalyst composite for exchanging hydrogen isotope in order to solve the above-described problem. Accordingly, the overlapping content with the above-described catalyst for exchanging hydrogen isotope is omitted, but is not limited thereto.

The present invention provides A method for manufacturing a catalyst composite for exchanging hydrogen isotope, the method comprising preparing a metal organic framework including an open metal site (OMS) and pores; forming a hydrophobically modified metal organic framework complex by introducing a hydrophobically modified compound into the OMS of the metal organic framework; reacting the hydrophobically modified metal organic framework complex with a catalyst matrix to disperse inside the catalyst matrix, and introducing a metal catalyst for hydrogen isotope exchange between the preparing and the forming, or between the forming and reacting, thereby solving the above-described problem. The catalyst composite for exchanging hydrogen isotope manufactured through the present manufacturing method has microscopic hydrophobicity, which prevents liquid water from covering the catalyst, which is detrimental to the catalytic efficiency, while not blocking the diffusion of water molecules, so that excellent reaction efficiency can be achieved in the hydrogen isotope exchange reaction.

First, as step (1), a metal organic framework including OMS and pores is prepared. At this time, a commercial metal organic framework can be used as the metal organic framework, or the metal organic framework can be synthesized directly. The synthesis of the metal organic framework can be used without limitation if it is a method known for the synthesis of metal organic frameworks, for example, it can be synthesized by a hydrothermal method. In addition, when performing step (1), the composition of the metal and organic linker included in the metal organic framework and the reaction conditions can be controlled to control the size of the pores of the metal organic framework.

In addition, in the case of the metal organic framework, an OMS that has already been formed can be used, and an OMS can also be artificially formed and used. At this time, the method of forming the OMS can be used without limitation if it is a method that can form an OMS in the metal organic framework, for example, it can be formed by a heat treatment method to remove water or solvent components included in the metal-organic framework.

Next, as a step (2), a hydrophobically modified compound is introduced into the OMS of the metal organic framework to form a hydrophobically modified metal organic framework complex. The method for introducing the hydrophobically modified compound into the metal organic framework can be used without limitation provided that it is a method that can introduce a compound into the OMS, for example, it can be a method of mixing the metal organic framework and the hydrophobically modified compound and then heating them to react. At this time, the reaction temperature and time can be appropriately selected depending on the types of the metal-organic framework and the hydrophobically modified compound, but for example, it can be a method of reacting at 0 to 150° C. for 0.1 to 168 hours.

In addition, the metal organic framework can be activated before introducing the hydrophobically modified compound. At this time, there is no limitation on the method of activation, for example, it can be a method of activating at 40 to 350° C. in a vacuum atmosphere for 0.1 to 168 hours.

In addition, the introducing a hydrophobically modified compound into the metal organic framework may be performed after the introducing a catalyst for exchanging hydrogen isotope into the metal organic framework described below, or may be performed before the step.

Next, as step (3), the hydrophobically modified metal organic framework complex is reacted with the catalyst matrix to disperse it inside the catalyst matrix. More specifically, the method of dispersion can be used without limitation in a conventional method, for example, if the catalyst matrix is a polymer compound, the polymer compound and the metal organic framework complex can be mixed and dispersed, and if the catalyst matrix is an inorganic material, a porous inorganic material, a metal organic framework complex, and a binder can be mixed and then formed and dispersed. At this time, the metal organic framework complex can be dispersed inside the catalyst matrix and the catalyst matrix can be synthesized at the same time, and an additional conventional compound required for synthesis can be added.

In addition, the method for manufacturing a catalyst composite for exchanging hydrogen isotope according to the present invention performs introducing a metal catalyst for hydrogen isotope exchange into the pores. The introducing a metal catalyst for hydrogen isotope exchange can be performed between the preparing and forming, or between the forming and the reacting.

More specifically, the method for introducing a metal catalyst for hydrogen isotope exchange into a metal organic framework can be used without limitation provided that it is a method capable of introducing a metal catalyst into a metal organic framework, for example, it can be a method of introducing a metal catalyst into the metal organic framework using a dual-solvent method.

In addition, more specifically, when introducing a metal catalyst for hydrogen isotope exchange into a metal organic framework, a method may be used in which a metal element for hydrogen isotope exchange is reacted with the metal organic framework to introduce the metal element, or a method may be used in which a precursor of the metal element for hydrogen isotope exchange is reacted with the metal organic framework and then reduced. At this time, the precursor of the metal element is not limited provided that it is in a form that can form a catalyst for hydrogen isotope exchange in the form of a metal element by reduction, for example, a compound comprising a metal ion in an oxidized form.

According to a preferred embodiment of the present invention, the water contact angle of hydrophobically modified metal organic framework complex may be 90° or more. When the water contact angle of the metal organic framework complex is 90° or more, the contact of liquid water with the catalyst can be effectively blocked, thereby preventing the liquid from covering the catalyst surface and preventing the contact between the catalyst and hydrogen gas, and at the same time, water vapor can easily diffuse into the metal organic framework and contact the catalyst, so that the efficiency of the hydrogen isotope exchange reaction can be much better than before. At this time, the water contact angle can be measured, for example, by dropping a water droplet on the above metal organic framework complex and then measuring the contact angle at the point where the water droplet and the metal organic framework complex come into contact.

At this time, more preferably, the hydrophobically modified metal organic framework complex can have a water contact angle of 90° or more and an average water vapor diffusivity of 5×10⁻¹⁴ cm²/s or more. When the water contact angle is 90° or more and the average water vapor diffusivity is 5×10⁻¹⁴ cm²/s or more, the effect of preventing the liquid water from contacting the catalyst and allowing the water vapor to easily diffuse into the metal organic framework is maximized, so that the efficiency of the hydrogen isotope exchange reaction can be significantly improved compared to the conventional art.

More specifically, the hydrophobically modified compound may include a compound represented by Chemical Formula 1.

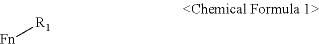

Wherein Fn includes any one of —NH₂, —NH—, —NRH, —N═, —NR₂, —C₅H₅N, —OH, —COOH, —PH₂, —PO₃²⁻ or —SH,

R₁ includes any one of a C1 to C20 alkyl group, a C1 to C20 heteroalkyl group, C1 to C20 aryl group or a C1 to C20 heteroaryl group.

At this time, more specifically, the R1 may exhibit hydrophobicity. When R1 is hydrophobic, the properties of the metal-organic framework complex can be controlled to be hydrophobic by introducing a hydrophobically modified compound into the OMS, and accordingly, microscopic hydrophobicity is introduced into the catalyst composite for exchanging hydrogen isotope, thereby preventing liquid water from covering the catalyst and thus being disadvantageous in terms of catalytic efficiency, while not blocking the diffusion of water molecules, thereby achieving excellent reaction efficiency.

More specifically, the present invention provides a catalyst composite for hydrogen isotope exchange produced by the method for manufacturing a catalyst composite for exchanging hydrogen isotope.

As the catalyst composite for hydrogen isotope exchange is manufactured by the above-described manufacturing method, the manufactured catalyst composite is capable of achieving excellent reaction efficiency by introducing microscopic hydrophobicity, while not blocking the diffusion of water molecules, thereby preventing liquid water from covering the catalyst and thus being disadvantageous in terms of catalytic efficiency.

In addition, the present invention provides a hydrogen isotope exchange method using the above-described catalyst composite for exchanging hydrogen isotope.

More specifically, the hydrogen isotope exchange method according to the present invention may be such that after filling the inside of the catalyst tower with the catalyst composite for exchanging hydrogen isotope, water is injected to the top of the tower and hydrogen gas is injected to the bottom of the tower to cause an isotope exchange reaction between the water and the hydrogen gas.

At this time, the catalyst tower is not limited, provided that it can support the catalyst composite for exchanging hydrogen isotope and can be used as a catalyst tower for hydrogen isotope exchange reaction, for example, it may be made of glass, and its shape and size may be appropriately selected according to its purpose and reaction scale.

At this time, for efficient fluid movement and reaction, the diameter of the catalyst tower may be 10 times or more the diameter of the catalyst composite, and the length of the catalyst tower may be 50 times or more the length of the catalyst composite.

In addition, the catalyst tower may be additionally provided with a liquid inlet for introducing liquid and a gas inlet for introducing gas, and a heating device may be additionally provided for heating the liquid before introducing the liquid into the liquid inlet to control the internal temperature. At this time, a typical heating device may be used without limitation as the heating device, and may be, for example, a hot plate.

In addition, the liquid inlet and the gas inlet of the catalyst tower may additionally be provided with a flow rate control unit for controlling the flow rates of the liquid and the gas. At this time, the flow rate control unit may be used without limitation provided that it is a flow rate control unit for controlling the flow rates of the liquid and the gas.

In addition, the gas inlet may have two or more inlets so that two or more types of gases can be injected, respectively, and each inlet may additionally be provided with a respective flow rate control unit so that the flow rates of each gas can be controlled.

In addition, more specifically, the catalyst tower may additionally be provided with a liquid discharge port for discharging liquid and a gas discharge port for discharging gas. At this time, water introduced into the liquid inlet may be discharged through the liquid discharge port or may be injected back into the catalyst tower through the liquid circulation unit. Accordingly, the catalyst tower may additionally be provided with a liquid circulation unit.

More specifically, water may be introduced into the above-described catalyst tower through the liquid inlet, and hydrogen gas may be introduced through the gas inlet. The introduced water and hydrogen gas come into contact with the catalyst composite for exchanging hydrogen isotope together, and a hydrogen isotope exchange reaction occurs in the catalyst, thereby exchanging hydrogen isotopes between water and hydrogen. After the reaction, water may be introduced into the liquid circulation unit for re-reaction or may be discharged to the outside through the liquid discharge port. In addition, hydrogen gas after the reaction may be discharged through the gas discharge port.

At this time, more specifically, a carrier gas may be injected together with hydrogen gas into the gas inlet, and the carrier gas may be used without limitation, but may preferably be an inert gas that does not affect the hydrogen isotope exchange reaction, and more preferably may be argon gas.

The present invention will be described more specifically through the following examples, but the following examples do not limit the scope of the present invention, and should be interpreted as helping to understand the present invention.

### Example 1

8.0 g of chromium (III) nitrate anhydride was dissolved in 9.5 ml of deionized (DI) water in a 500 mL Teflon-liner. After complete dissolution, 3.32 g of terephthalic acid and 0.72 ml of hydrofluoric acid were added, and then stirred vigorously. Then, the mixture was hydrothermally reacted in an autoclave at 220° C. for 8 hours. After that, the reaction product was slowly cooled to room temperature, and the mixture was filtered and washed twice with deionized water and DMF at 70° C., respectively, with vacuum filtration performed between each washing step to obtain MIL-101. After that, MIL-101 was vacuum-dried at 150° C., and the activated MIL-101 was dispersed in anhydrous n-hexane. Thereafter, a 2.5 wt % aqueous solution of chloroplatinic acid hexahydrate (H₂PtCl₆·6H₂O), a precursor of a platinum catalyst, was added dropwise at a rate of 15 μL/min using a syringe pump while stirring vigorously. The product was then filtered, washed with ethanol, and dried overnight at 150° C. in a vacuum. Then, the obtained powder was reduced at a ramp rate of 2° C./min under hydrogen condition at 190° C. for 5 h, followed by argon purge before and afterward, to obtain Pt@MIL-101, which is platinum-impregnated MIL-101. Then, 1.0 g of Pt@MIL-101 activated at 150° C. in a vacuum and 1.0 g of dodecylamine were dispersed in 250 mL of cyclohexane for dodecylamine grafting. Then, the mixture was heated at 85° C. for 48 h and then vacuum filtered. At this time, the obtained powder was washed with DMF and dried overnight at 120° C. under vacuum condition to obtain dodecylamine grafted Pt@MIL-101, Pt@MIL-101-12. Finally, to prepare Pt@MIL-101-12/PVDF composite, deionized water was first mixed with DMF and then lithium chloride was completely dissolved. Then Pt@MIL-101-12 was added and dispersed evenly, and then PVDF powder was added and mixed vigorously. Then the mixture was heated and mixed overnight in a sealed container. At this time, the mass compositions of the above chemicals were added in the following mass ratios, respectively: PVDF 11.7 wt %, Pt@MIL-101-12 11.7 wt %, deionized water 1.1 wt %, lithium chloride 2.5 wt %, and the remainder was DMF. Thereafter, the uniformly mixed solution was poured into a tank filled with water, which is a nonsolvent of PVDF, to exchange the DMF in the solution and coagulate the PVDF into a fiber form. After that, the solvent in the tank was sequentially replaced with fresh deionized water and hexane, and the fibers were left in the solvent for one day each. After the solvent exchange process, the fibers were air-dried at room temperature and then further dried at 100° C. in a vacuum. The final catalyst-polymer composite Pt@MIL-101-12/PVDF obtained thereafter was prepared by cutting the fibers into a length and diameter of about 3 mm and 1-2 mm, respectively.

### Example 2

Pt@MIL-101-12 was obtained by manufacturing in the same manner as in Example 1, but only up to the process of introducing dodecylamine.

### Comparative Example 1

The same MIL-101 (Cr) used in Example 1 was prepared.

### Comparative Example 2

Made in the same manner as in Example 1, but the process of introducing platinum was omitted and dodecylamine was introduced, thereby obtaining MIL-101-12 in which dodecylamine was introduced into the metal organic frame.

### Comparative Example 3

Pt@MIL-101 was obtained by manufacturing in the same manner as in Example 1, but only up to the process of introducing platinum.

### Experimental Example 1—XRD Analysis

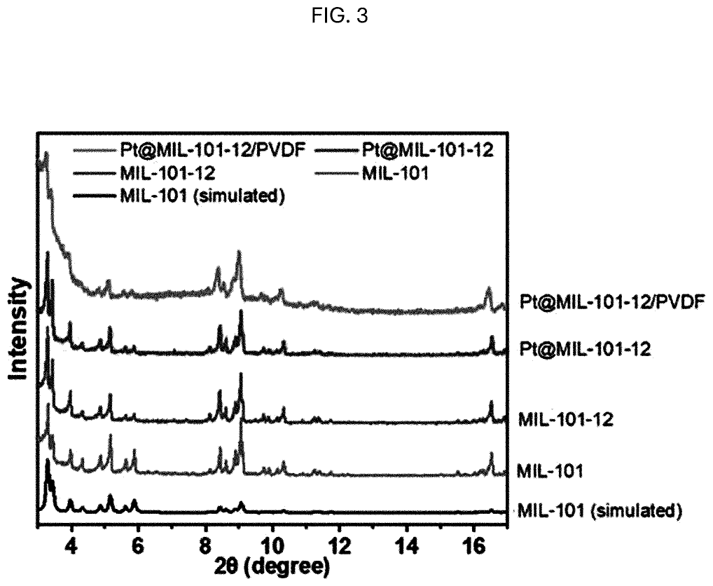

XRD (X-ray diffraction) analysis was performed on Example 1, Example 2, Comparative Example 1, and Comparative Example 2, and the results are shown in FIG. 3. The measurement was performed using an X-ray diffractometer (SmartLab, Rigaku) with Cu Kα radiation (λÅ) at an angle increasing by 0.01°.

As can be seen in FIG. 3, the XRD spectra of each example and comparative example are almost unchanged. However, in Example 1, Example 2, and Comparative Example 2, the intensity of the spectra at 20 of 5.8° was slightly reduced, which is because dodecylamine, an amorphous alkyl chain, was introduced into OMS. In addition, although the spectrum of Example 1 changed slightly in the section where 20 was 4.5 or less, this was not due to a change in the structure of the metal organic framework, but due to the amorphous characteristics of the polymer. Therefore, it can be confirmed that the structure of the metal organic framework is maintained even with the introduction of dodecylamine and dispersion into PVDF.

### Experimental Example 2—Texture Analysis

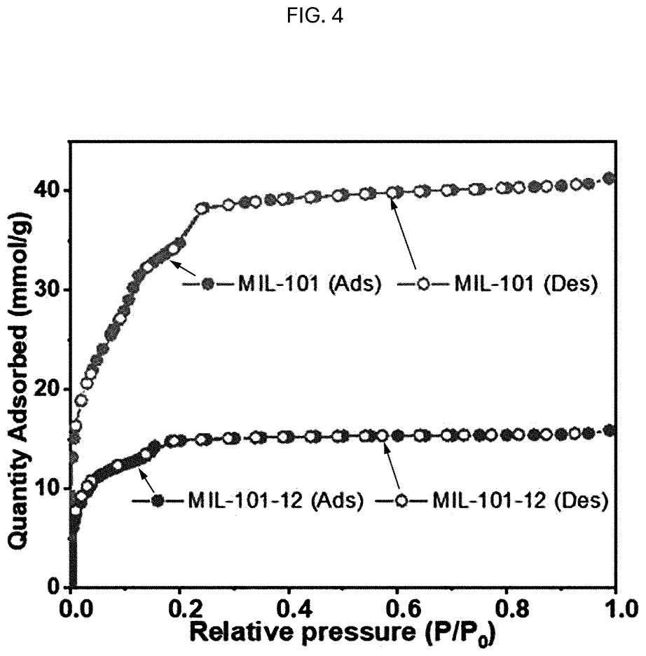

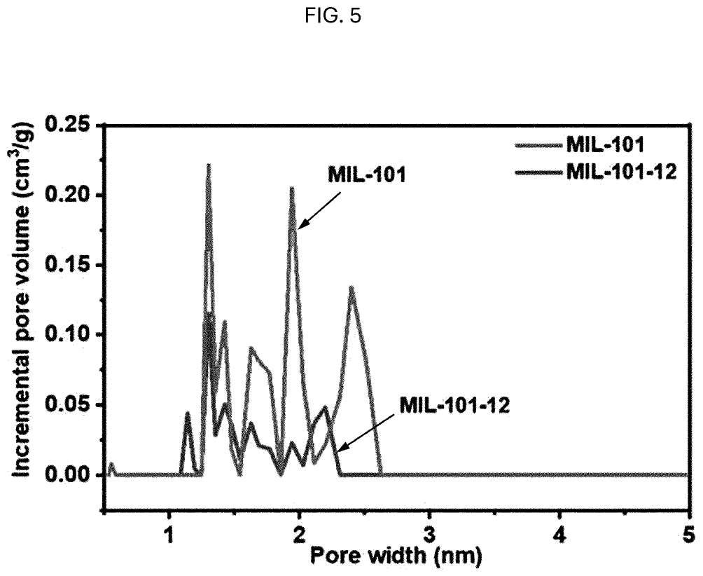

For Comparative Examples 1 and 2, N₂ adsorption experiments were performed at extremely low temperatures (77 K), and the adsorption curves are shown in FIG. 4. In addition, the pore size distribution was measured using nonlocal density functional theory (NLDFT) based on the adsorption curves, and the results are shown in FIG. 5. In addition, the BET (Brunauer-Emmett-Teller) surface area and pore size distribution are shown in Table 1. A physisorption instrument (Micromeritics, ASAP 2020) was used for the analysis.

TABLE 1

| | Comparative | Comparative |
|---|---|---|
| | Example 1 | Example 2 |
| BET surface area (m²/g) | 2314.4 | 1105.9 |
| Pore volume (cm³/g) | 1.4043 | 0.5372 |
| Average pore diameter (nm) | 2.26 | 2.07 |

As can be seen in FIG. 4, FIG. 5, and Table 1, it can be confirmed that the BET surface area, pore volume, and average pore diameter values of Comparative Example 2 were all reduced compared to Comparative Example 1. This is a change caused by the introduction of dodecylamine into the metal organic frame, and through this, it can be confirmed that dodecylamine was properly introduced, and through this, it can be inferred that dodecylamine was properly introduced in Examples 1 and 2, which introduced dodecylamine through the same process.

### Experimental Example 3—FT-IR Analysis

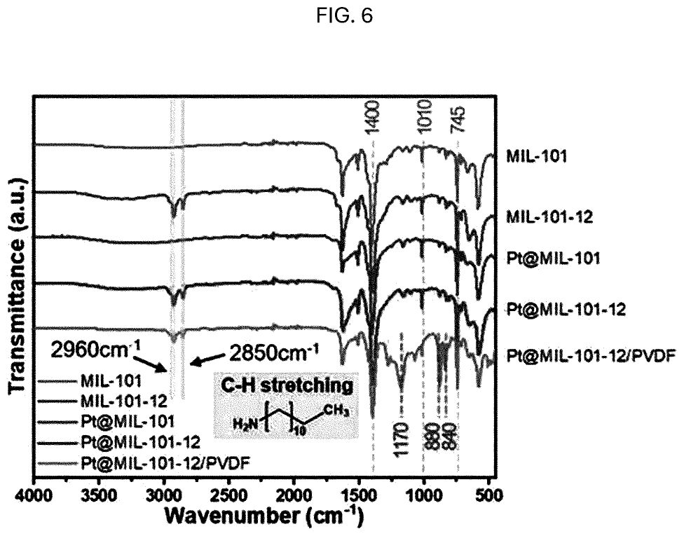

FT-IR analysis was performed on Example 1, Example 2, and Comparative Examples 1 to 3, and the results are shown in FIG. 6. Measurements were made using an FT-IR Spectrometer (Thermo Fisher Scientific Instrument, Nicolet iS50) in the wavenumber range of 400 cm⁻¹ to 4000 cm⁻¹.

In all examples and comparative examples, peaks at 1505 cm⁻¹, 1400 cm⁻¹, 1010 cm⁻¹, and 745 cm⁻¹ due to MIL-101 were observed. In addition, peaks at 1170 cm⁻¹, 880 cm⁻¹, and 840 cm⁻¹ originating from the PVDF matrix were observed in Example 1. In addition, two peaks at 2960 cm⁻¹ and 2850 cm⁻¹ were observed in Example 1, Example 2, and Comparative Example 2, which were peaks originating from the C—H bond of dodecylamine, suggesting that dodecylamine was successfully introduced in Example 1, Example 2, and Comparative Example.

### Experimental Example 4—SEM Photography

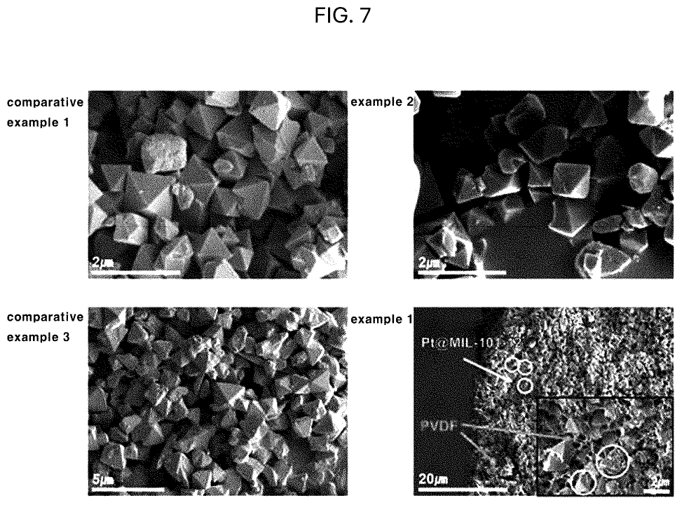

The shape of the nanocrystals of Example 1, Example 2, Comparative Example 1, and Comparative Example 3 was photographed using a scanning electronic microscopy (SEM), and the photographs are shown in FIG. 7. An SEM (FEI company, Magellan400) was used.

As can be seen in FIG. 7, the octahedral shape of MIL-101 was maintained even after Pt was introduced into the pores, and also after dodecylamine was introduced. In addition, as shown in the photograph of Example 1, it can be confirmed that the octahedral structure of PVDF is uniformly dispersed and integrated within the PVDF matrix.

### Experimental Example 5—Scanning Transmission Electron Microscope (HAADF-STEM) and Energy-Dispersive X-ray Spectroscopy (EDS) Analysis

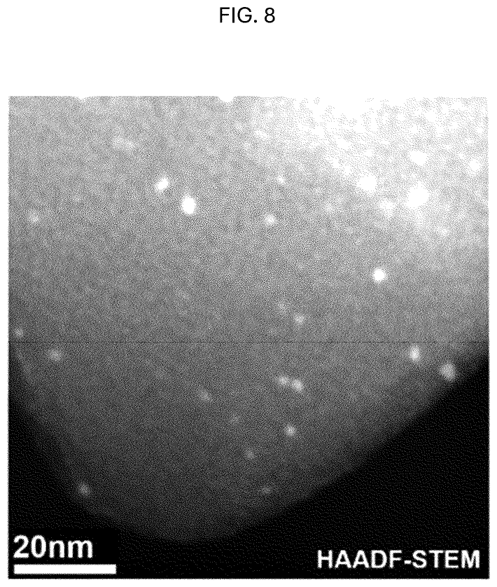

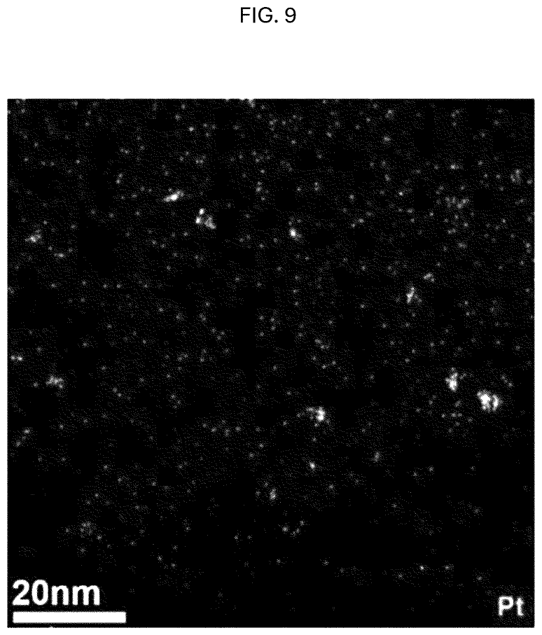

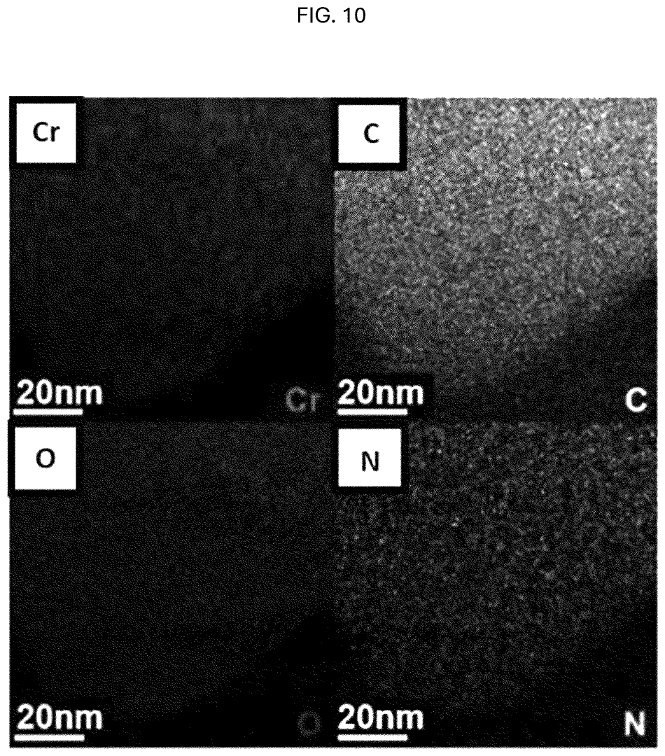

For Example 2, high-angle annular dark-field imaging analysis was performed using HAADF-STEM, and the results are shown in FIG. 8. Pt was mapped using EDS analysis, and the results are shown in FIG. 9. Mapping was also performed for Cr, C, O, and N, and the results are shown in FIG. 10. At this time, STEM (Talos F200X G2, Thermo Fisher) was used for HAADF-STEM and EDS analysis.

As can be seen from FIGS. 8 and 9, Pt particles are very uniformly dispersed inside Pt@MIL-101-12 of Example 2. Also, as can be seen in FIG. 10, chromium, carbon, oxygen, and nitrogen are very uniformly distributed, which suggests that dodecylamine was very uniformly introduced into the metal organic framework.

### Experimental Example 6—TEM Analysis

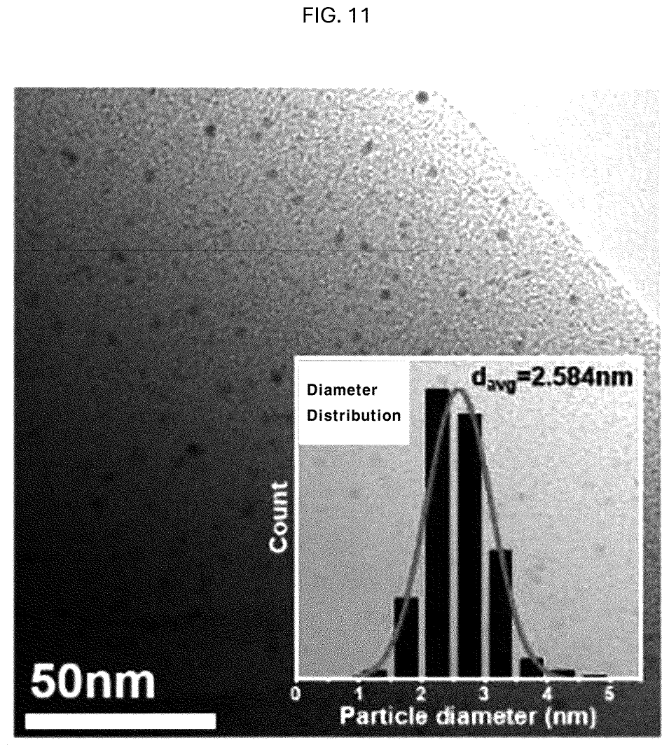

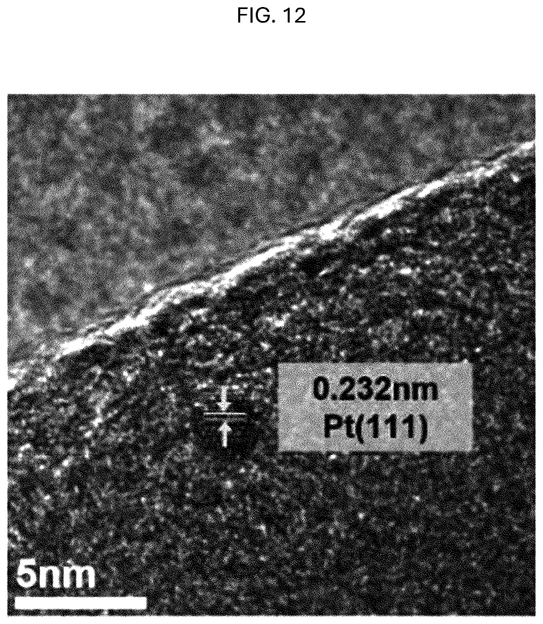

Example 2 was photographed using a TEM (transmission electron microscope), and the photograph is shown in FIG. 11. In addition, four TEM images were randomly selected, and the diameters of the dark spots were randomly measured for 50 each, and the distribution was shown in FIG. 11. In addition, the TEM was photographed again at a 10-fold magnification compared to FIG. 11, and the photograph is shown in FIG. 12. At this time, TEM (FEI, Tecnai Ge F30 S-Twin) was used for observation under a 300 kV electron beam.

As can be seen in FIG. 11, the Pt particles were evenly distributed, which is the same result as that shown in Experimental Example 5. In addition, the average diameter of Pt nanoparticles calculated in FIG. 12 is calculated as 2.58±0.52 nm, which is similar to the pore size of MIL-101 observed in Experimental Example 2, suggesting that Pt nanoparticles were successfully introduced into the metal organic framework. In addition, in FIG. 12, Pt particles with a diameter of 0.232 nm were confirmed. In addition, the dark spots in FIG. 12 appeared only after reduction of Pt, confirming that the dark spots were Pt particles.

### Experimental Example 7—Inductively Coupled Plasma Optical Emission Spectroscopy Analysis

ICP-OES (Inductively Coupled Plasma Optical Emission Spectroscopy) analysis was performed on Example 1, Example 2, and Comparative Examples to measure the contents of Pt and Cr, respectively, and the results are shown in Table 2. For each Example and Comparative Example, the samples were treated overnight at 120° C. in a vacuum oven, and then measured using ICP-OES (Agilent, ICP-OES 720) equipment.

TABLE 2

| | Pt content | Cr content |
|---|---|---|
| | (mg/kg dry basis) | (mg/kg dry basis) |
| Example 1 | 5464 | 78026 |
| Comparative | 14847 | 194673 |
| Example 3 | | |
| Example 2 | 10992 | 156755 |

As can be seen in Table 2, when comparing Comparative Example 3 with Example 2, the total mass increased due to the attachment of alkyl chains caused by the introduction of dodecylamine, and the relative amounts of Pt and Cr decreased somewhat. In addition, in the case of Example 1, which was manufactured by mixing Pt@MIL-101-12 and PVDF in a mass ratio of 1:1, it can be confirmed that the relative amounts of Cr and Pt were approximately half that of Example 2. This confirms that Pt is not desorbed by the introduction of dodecylamine or dispersion within the PVDF, but is introduced within the metal organic framework while maintaining almost the same initial amount.

### Experimental Example 8—Elemental Analysis

Elemental analysis was performed on Example 2, and the results are shown in Table 3. For the analysis, a Flash 2000 series Elemental Analyzer (Thermo Scientific) was used.

TABLE 3

| Element | Weight % |
|---|---|
| C | 49.53 |
| H | 5.85 |
| N | 2.54 |

As can be seen in Table 3, it can be confirmed that 2.54 wt % of nitrogen was introduced for Example 2. This is the nitrogen of dodecylamine measured, and through this, it can be confirmed that dodecylamine was introduced into the metal organic framework. In addition, according to the amount of chromium measured in the ICP-OES analysis in Experimental Example 7 and the amount of nitrogen in Experimental Example 8, the N/Cr molar ratio of Example 2 is calculated to be 0.495, and when compared with the theoretical N/Cr molar ratio of 0.667 of MIL-101, it can be inferred that dodecylamine was introduced to 73.9% of the total OMS.

### Experimental Example 9—XPS Analysis

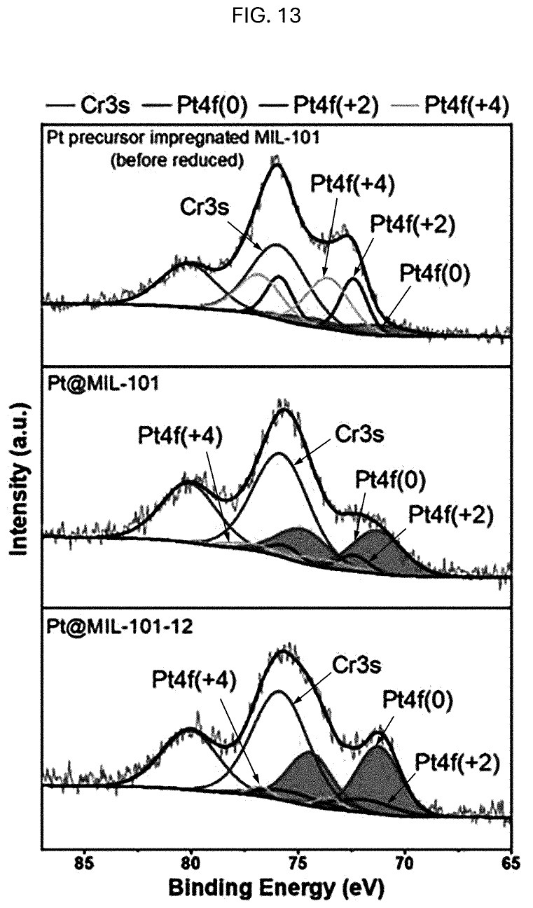

In order to analyze the oxidation state of platinum contained in Comparative Example 3 which did not perform the platinum reduction step, Comparative Example 3, and Example 2, XPS (X-ray electron spectroscopy) analysis was performed, and the results are shown in FIG. 13. For the analysis, XPS (Thermo Scientific, Nexsa G2) equipment was used, and the analysis was performed using Avantage Data System software.

As can be seen in FIG. 13, when comparing Comparative Example 3, which did not perform the platinum reduction step, and Comparative Example 3, which performed the platinum reduction step, the peaks at 76.8 eV and 73.6 eV corresponding to Pt4f(+4) almost disappeared during the reduction, whereas the peaks at 71.2 eV and 74.4 eV corresponding to Pt4f(0) were significantly dominant. In addition, this trend was maintained in Example 2. This means that platinum was converted into a form that can function as a catalyst through the reduction process, and that this state was maintained even after the introduction of dodecylamine.

### Experimental Example 10—XANES Analysis

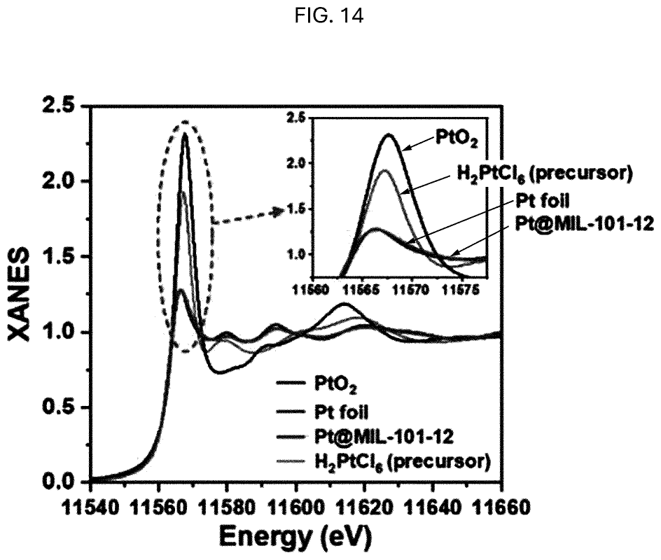

In order to analyze the chemical state of the platinum catalyst introduced into the metal organic framework, XANES (X-ray absorption near edge structure) analysis was performed on Example 2, and the results were compared with the results of Pt foil, PtO₂, and H₂PtCl₆ (precursor of the platinum catalyst), and the results are shown in FIG. 14. Wide XAFS (Pohang light source, 10C) equipment was used for the analysis.

As can be seen in FIG. 14, the intensity of the peak of Example 2 is distinct from that of PtO₂ and H₂PtCl₆ and is almost the same as that of the Pt foil. This indicates that the electronic state of the platinum introduced into the metal organic framework is almost the same as that of the metal Pt, which means that the platinum still exists in a reduced state that can function as a catalyst even after the preparation of the metal organic framework complex.

### Experimental Example 11—EXAFS Analysis

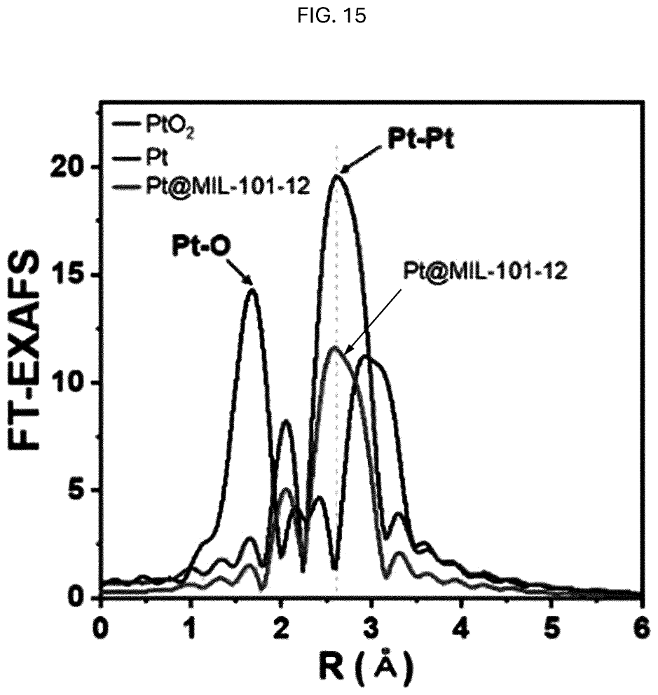

In order to analyze the chemical state of the platinum catalyst introduced into the metal organic framework, EXAFS (Extended X-ray absorption fine structure) analysis was performed on Example 2, and the results were compared with the results of Pt foil and PtO₂, and the results are shown in FIG. 15. Wide XAFS (Pohang light source, 10C) equipment was used for the analysis.

As can be seen in FIG. 15, the main peaks of Example 2 are very similar to those of Pt foil and different from those of PtO₂, which means that this indicates a dominant coordination degree of Pt—Pt and that the coordination degree of Pt—O is negligible. This means that most of the Pt nanoparticles introduced into the metal organic framework complex exist in a metallic state, and can act as a catalyst for hydrogen isotope exchange reaction. In addition, the specific Pt—Pt coordination number was 9.46±0.94, and through this, the average diameter of the nanoparticles could be calculated to be approximately 25 Å, which is consistent with the average diameter of the nanoparticles in the previous Experimental Example 6, which was 25.8 Å.

### Experimental Example 12—Water Vapor Adsorption Evaluation

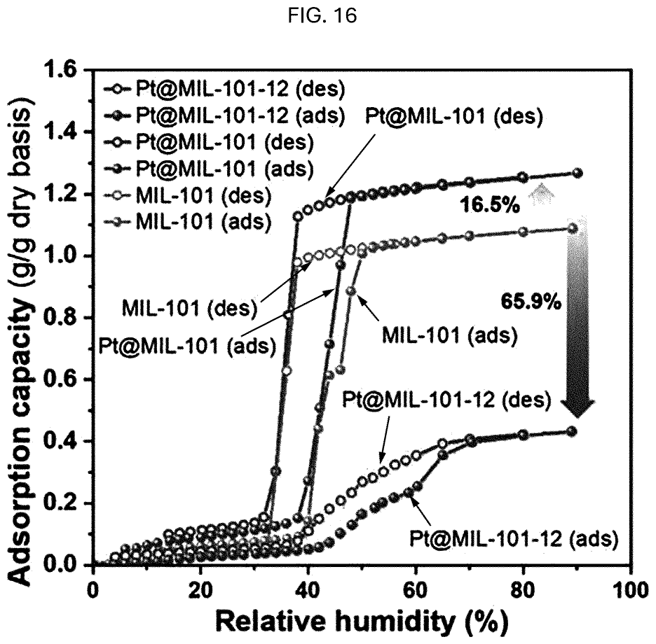

In order to measure the water repellency after the introduction of the hydrophobically modified compound, water vapor adsorption isotherms were obtained for Comparative Example 1, Comparative Example 3, and Example 2, and are shown in FIG. 16. At this time, for evaluation, analysis was performed using a vapor sorption analyzer (TA instruments, VTI-SA+) at 25° C. and a relative humidity ranging from 4 to 90%, and measurements were made in 2% increments up to 60% relative humidity, and in 10% increments thereafter. The measurement was made by measuring the mass difference based on a sample left undisturbed for 12 hours in a nitrogen atmosphere at 120° C. At this time, if the mass change was less than 0.001 wt (%) for 5 minutes, it was considered to be in an equilibrium state, and the maximum equilibrium time for analysis was set to 6 hours.

As can be seen in FIG. 16, in the case of Comparative Example 1 and Comparative Example 3, in which a hydrophobically modified compound was not introduced, it can be confirmed that the water absorption is very high. This is because after water molecules are attached to the OMS of the metal organic framework, multimolecular water chains grow centered on the attached water molecules. In addition, it was confirmed that in Comparative Example 3, the maximum water adsorption capacity increased by 16.5% compared to Comparative Example 1 due to the introduction of hydrophilic Pt. In contrast, in the case of Example 2, in which a hydrophobically modified compound was introduced, the water adsorption capacity decreased by 65.9% compared to Comparative Example 3, showing very excellent water repellency. In addition, in the case of Comparative Example 1 and Comparative Example 3, the water absorption increases rapidly in the section where the ambient humidity is 40%, while in the case of Example 2, the water absorption gradually increases from 45%. This is also because the microscopic hydrophobicity is excellent due to the hydrophobically modified compound. By introducing a hydrophobically modified compound into the OMS in this way, it is possible to prevent bulk liquid water from covering the catalyst surface and blocking contact with hydrogen gas, compared to when it is not introduced into the OMS. As result, the efficiency of the hydrogen isotope exchange reaction can be significantly improved compared to conventional method.

### Experimental Example 13—Evaluation of Water Vapor Diffusivity

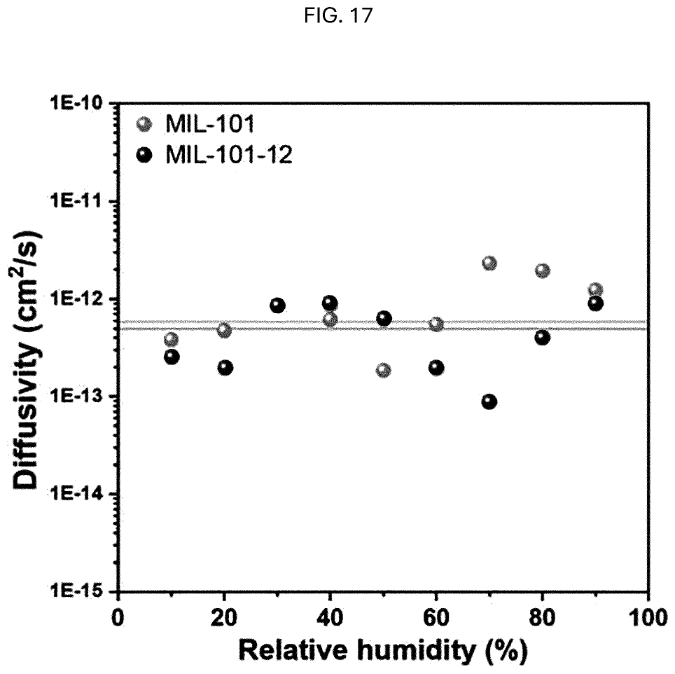

In order to measure the change in the degree of contact of water molecules with the catalyst due to the introduction of hydrophobic modified compounds, the water vapor diffusivity was evaluated for Comparative Example 1 and Comparative Example 2, and the results are shown in FIG. 17. For the analysis, a vapor sorption analyzer (TA instruments, VTI-SA+) was used at 25° C. At this time, the average water vapor diffusivity was calculated at a relative humidity of 0 to 100%. At this time, the water vapor diffusivity (Di) at each relative humidity was calculated after evaluating the time-dependent adsorption isotherm at each relative humidity, and then fitting the adsorption isotherm according to the Fickian diffusion model expressed by the following Mathematical Equation 1. The time-dependent adsorption isotherm was plotted at each relative humidity, with t^{1/2}(s^{1/2}) as the x-axis, and the ratio of the water vapor adsorption amount by time to the maximum water vapor adsorption amount was plotted accordingly. FIG. 18 shows the experimental results of the water vapor adsorption isotherm at 25° C. and 90% relative humidity, with the x-axis representing s^{1/2} and the y-axis representing the ratio of the amount of water vapor adsorption per hour to the maximum amount of water vapor adsorption, and then fitting each result according to the Fickian diffusion model of the Mathematical Equation 1.

$$\frac{{M}_{t}}{{M}_{∞}} = \text{} 1 - \text{} \frac{3 D}{β {a}^{2}} exp \text{} ( - β t ) \text{} \{ 1 - {( \frac{β a}{D} )}^{\frac{1}{2}} cot {( \frac{β {a}^{2}}{D} )}^{\frac{1}{2}} \} + \text{} \frac{6 β {a}^{2}}{{π}^{2} D} \text{} {{\sum }^{∞}}_{n = 1} \frac{exp ( - \frac{{Dn}^{2} {π}^{2} t}{{a}^{2}} )}{{n}^{2} ( {n}^{2} {π}^{2} - \frac{β {a}^{2}}{D} )} \qquad 〈 Mathematical Equation 1 〉$$

$${D}_{i} = water vapor diffusivity$$

$${M}_{t} = total amount of solute at a specific time t$$

$${M}_{∞} = total amount of solute at infinite time ( t {=}^{∞} )$$

$$β = parameter representing the adsorption and desorption rate of solute .$$

$$a = pore radius$$

As can be seen in FIG. 17, the water vapor diffusivity was largely independent of the relative humidity, and the average water vapor diffusivity of Comparative Example 1 was 5.87×10⁻¹³ cm/s, while that of Comparative Example 2 was 4.91×10⁻¹³ cm/s, showing no significant difference. This means that, compared to Experimental Example 12, the introduction of the hydrophobically modified compound can prevent bulk liquid water from accumulating on the metal catalyst for hydrogen isotope exchange, while not blocking the access of water molecules itself. This is because microscopic hydrophobicity was introduced due to the unique structure of the present invention in which the metal catalyst for hydrogen isotope exchange was introduced into the metal organic framework into which the hydrophobically modified compound was introduced, and thereby the efficiency of the hydrogen isotope exchange reaction is maximized, which can be significantly superior to the conventional art.

### Experimental Example 14—Water Contact Angle Evaluation

In order to evaluate the macroscopic water repellency, the water contact angles were evaluated for Example 1, Comparative Example 1, Comparative Example 2, and Example 2, and the pictures are shown in FIG. 19. For the analysis, an angle analyzer (SEO, Phoenix 300) was used, and the analysis was performed using Surfaceware 9 software. In the case of Comparative Example 1, Comparative Example 2, and Example 2, the powder was evenly spread on a glass plate and measured, and in Example 1, a thin film was formed with the same composition and manufacturing method and measured.

As can be seen in FIG. 19, in the case of Comparative Example 2 and Example 2, where a hydrophobically modified compound was introduced, it can be confirmed that they have excellent macroscopic water repellency, with a water contact angle of 90° or more. This can be said to be very excellent compared to Comparative Example 1, which has almost no water repellency performance. In addition, in the case of Example 1 where a metal organic framework complex was introduced into PVDF, it was confirmed that very excellent macroscopic water repellency was achieved.

### Experimental Example 15—Impregnation Evaluation

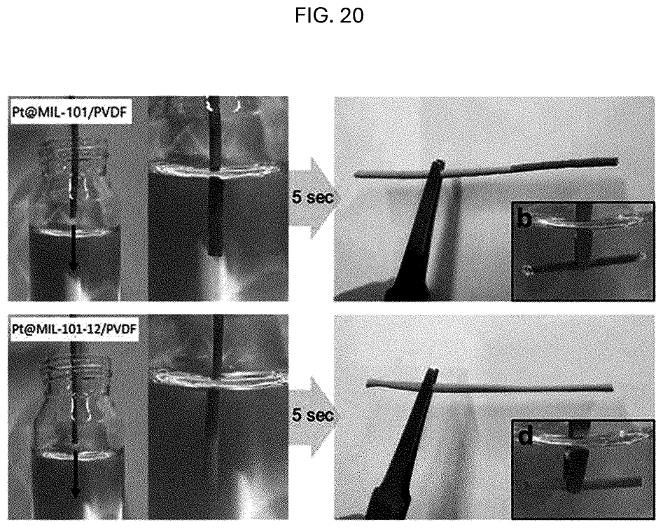

The Pt@MIL-101/PVDF, prepared by dispersing in PVDF using the same method as in Example 1 for both Example 1 and Comparative Example 3, was impregnated in deionized water for 5 seconds to evaluate its macroscopic hydrophobicity. The results are shown in FIG. 20.

As can be seen in FIG. 20, in the case of Example 1, the original surface color was maintained even after impregnation in deionized water for 5 seconds, indicating that bulk liquid water did not penetrate into the interior. In contrast, in the case of Pt@MIL-101/PVDF, a clear color change was observed after impregnation in deionized water for 5 seconds, indicating that water had penetrated. In addition, when impregnated with deionized water, it can be seen that while no bubbles were generated in the case of Example 1, bubbles were generated in the case of Pt@MIL-101/PVDF. This also means that water penetrated Pt@MIL-101/PVDF while Example 1 did not. Therefore, it was confirmed that the introduction of the hydrophobically modified compound effectively blocks bulk liquid water from directly contacting the metal catalyst for hydrogen isotope exchange by introducing microscopic hydrophobicity.

### Experimental Example 16—Column Efficiency Evaluation

For Pt@MIL-101/PVDF, which was manufactured by dispersing Example 1 and Comparative Example 3 in PVDF in the same manner as Example 1, the column efficiency was evaluated to compare the efficiency of the actual hydrogen isotope exchange reaction. FIG. 2 is a schematic diagram of the isotope exchange reactor. More specifically, the catalytic reactor was manufactured with a glass column having an inner diameter of 10 mm and a length of 150 mm, and water was allowed to flow at a constant rate from the liquid inlet located at the top of the reactor, and a hot plate and a heating tape were installed before the liquid inlet to adjust the temperature of the water. In addition, hydrogen gas was allowed to be injected at a constant rate from the gas inlet located at the bottom of the reactor, and argon gas was also injected as a carrier gas at this time. The liquid was discharged through the liquid discharge port at the bottom after the reaction, and a porous glass filter was attached to the bottom to prevent the catalyst composite from leaking through the liquid discharge port and gas inlet located at the bottom. In addition, the gas was discharged through the gas discharge port at the top after the reaction.

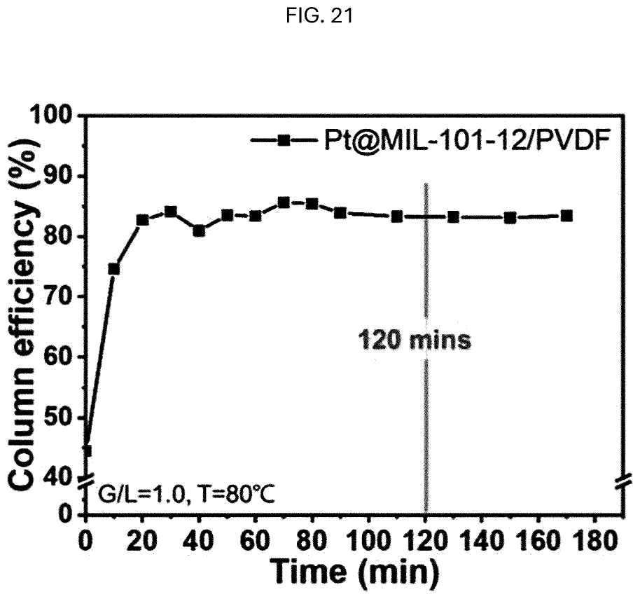

At this time, the amount of each catalyst composite for exchanging hydrogen isotope was adjusted so that the mass of platinum contained in each was 5 mg, and the flow rate of the injected water was fixed at 0.2 ml/min. The molar ratio of the gas-liquid flow rate was performed in the range of 0.5 to 20, and the temperature range was measured in the range of 40 to 80° C. At this time, deionized water was used as a liquid and hydrogen gas as a gas for the reaction. Since deuterium and tritium differ only in the isotope separation coefficient, the experimental results for deuterium can be applied to tritium with the same tendency. After the reaction, the liquid product was collected, and the product was analyzed with an isotopic water analyzer (PICARRO, L2140-i) to measure its isotope content. The concentration of deuterium atoms was measured at least 8 times for a single case, and the average value of the last 3 measurements was applied, and VSMOW2, SLAP2, GRESP, and IAEA 604 were used as standard solutions for the measurement. In addition, the measurement was performed 2 hours after the start of the reaction, because the reaction reaches a stable phase 90 minutes after the start of the reaction, as can be seen in FIG. 21.

In addition, the column efficiency was calculated using the following method.

$$η ≡ \frac{{y}_{out} - {y}_{in}}{{y}_{out}^{*} - {y}_{in}} \qquad 〈 Mathematical Equation 2 〉$$

$$η = column efficiency$$

$${y}_{out} = atomic concentration of deuterium at the gas discharge port$$

$${y}_{in} = atomic concentration of deuterium at the gas inlet$$

$${y}_{out}^{*} = atomic concentration of deuterium at the gas discharge prot at theoretical equilibrium$$

At this time, the column efficiency can be obtained by the following method.

$${x}_{in} \cdot L + {y}_{in} \cdot G = {x}_{out} \cdot L + {y}_{out} \cdot G \qquad 〈 Mathematical Equation 3 〉$$

$${y}_{out} = atomic concentration of deuterium at the liquid discharge port$$

$${y}_{in} = atomic concentration of deuterium at the liquid inlet$$

$$L = flow rate of the liquid being injected$$

$$G = flow rate of the gas being injected$$

$$π = \frac{L}{G} \qquad 〈 Mathematical Equation 4 〉$$

Mathematical Equation 3 illustrates the mass balance equation, and the flow rate ratio of gas and liquid can be defined as in Mathematical Equation 4. At this time, based on Mathematical Equations 3 and 4, if it is assumed that the liquid and gas of a specific concentration injected into the column are in equilibrium when discharged, the mass balance equation in the equilibrium state can be derived as in Mathematical Equation 5.

$${x}_{in} \cdot π + {y}_{in} = {x}_{out}^{*} \cdot π + {y}_{out}^{*} \qquad 〈 Mathematical Equation 5 〉$$

$${x}_{out}^{*} = atomic concentration of deuterium at the liquid discharge port at theoretical equilibrium$$

$$α ≡ \frac{x ( 1 - y )}{y ( 1 - x )} \qquad 〈 Mathematical Equation 6 〉$$

At this time, the distribution coefficient between liquid and gas can be defined as in Mathematical Equation 6, and if x*ₒᵤₜ <<1, y*ₒᵤₜ <<1, Mathematical Equation 7 below can be derived from Mathematical Equations 5 and 6.

$${y}_{out}^{*} = \frac{{x}_{in} \cdot π + {y}_{in}}{α \cdot π + 1} \qquad 〈 Mathematical Equation 7 〉$$

Unlike the derivation of Mathematical Equation 7, if Mathematical Equations 5 and 6 are combined without assuming that x*ₒᵤₜ <<1, y*ₒᵤₜ <<1, x*ₒᵤₜ and y*ₒᵤₜ can be calculated as in Mathematical Equations 8 and 9 below.

$${x}_{out}^{*} = \frac{- B + \sqrt{{B}^{2} - 4 AC}}{2 A} \qquad 〈 Mathematical Equation 8 〉$$

$$( A = π - πα , B = πα + α {y}_{in} + πα {x}_{in} - {y}_{in} - π {x}_{in} + 1 , C = - πα {x}_{in} - α {y}_{in} )$$

$${y}_{out}^{*} = \frac{- {B}^{′} + \sqrt{{B}^{′2} - 4 {A}^{′} {C}^{′}}}{2 {A}^{′}} \qquad 〈 Mathematical Equation 9 〉$$

$$( A = α - 1 , B = πα + 1 + π {x}_{in} - {y}_{in} - πα {x}_{in} - α {y}_{in} , C = - π {x}_{in} - {y}_{in} )$$

At this time, the column efficiency can be derived by substituting y*ₒᵤₜ derived through the Mathematical Equation 9 into Mathematical Equation 5, and through this, a quantitative comparison of the catalyst composite performance is possible. In addition, the temperature-dependent separation coefficient (α) of the hydrogen isotope exchange reaction was calculated as shown in the following Mathematical Equation 10.

$$ln α = - 0.2143 + \frac{368.9}{T} + \frac{27870}{{T}^{2}} \qquad 〈 Mathematical Equation 10 〉$$

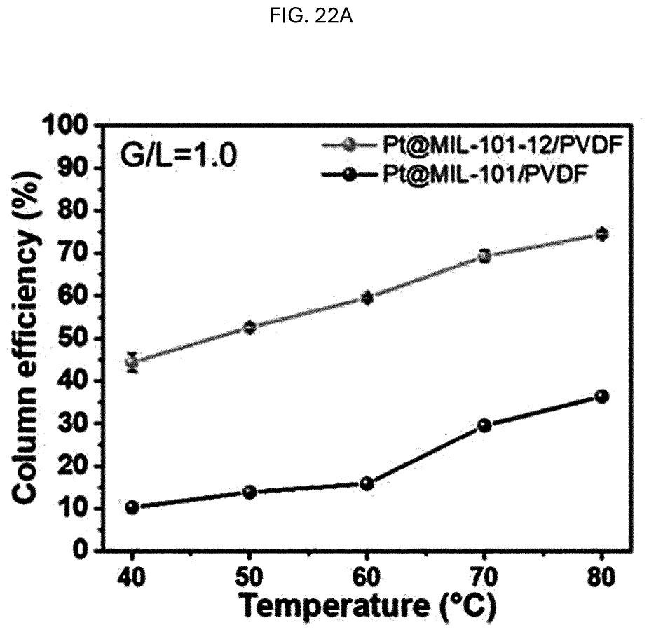

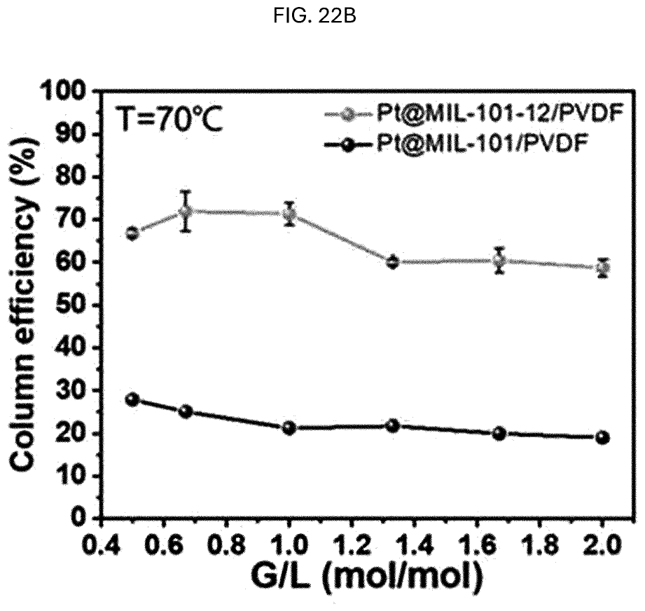

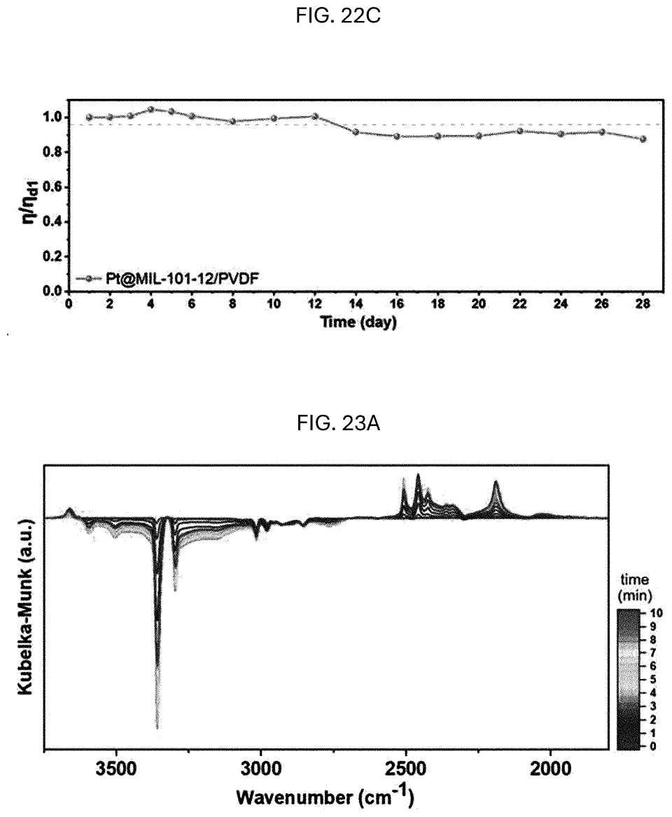

The column efficiency was calculated using as described above, and the Pt@MIL-101/PVDF, prepared by dispersing in PVDF using the same method as in Example 1 for both Example 1 and Comparative Example 3, was reacted while fixing the G/L value at 1.0 and varying the temperature from 40° C. to 80° C. The comparison of column efficiency under these conditions is shown in FIG. 22A. In addition, the column efficiency was compared in cases where the temperature was fixed to 70° C. and the G/L value was varied from 0.5 to 2.0, and the column efficiency was shown in FIG. 22B. In addition, for Example 1, when the G/L was fixed to 1.0 and the temperature was fixed to 70° C., the reaction was performed for 28 days, and the column efficiency was measured, and the ratio to the column efficiency value on the first day was measured, and the result was shown in FIG. 22C.

As can be seen from FIGS. 22A and 22B, Example 1, into which a hydrophobically modified compound was introduced, has a much better column efficiency than Pt@MIL-101/PVDF, into which a hydrophobically modified compound was not introduced. This directly suggests that the introduction of microscopic hydrophobicity into the catalyst composite according to Example 1 prevents the bulk liquid water from covering the catalyst, thereby preventing deactivation of the catalyst while not blocking the access of water vapor molecules, thereby improving the efficiency of the hydrogen isotope exchange reaction. In addition, as can be seen from FIG. 22C, in the case of Example 1, it can be confirmed that the column efficiency is maintained at an almost constant level for 28 days. This shows that the catalyst composite according to the present invention effectively blocks bulk liquid water while allowing the access of appropriate water vapor in the hydrogen isotope exchange reaction, and thus the performance of preventing catalyst deactivation is maintained for a very long period of time.

Additionally, the natural concentrations of deuterium contained in the deionized water and hydrogen gas used in the present invention are 147 μmol/mol (D/(D+H)) and 135 μmol/mol (D/(D+H)), respectively, which are ultra-low isotope concentration ranges close to the tritium concentration range of actual industrial wastewater. In the case of Example 1, it can be confirmed that very excellent column efficiency was shown even in this concentration range, and when compared to the previous studies on catalysts for hydrogen isotope exchange performed in a very high hydrogen isotope concentration range, it can be seen that the catalyst composite for exchanging hydrogen isotope according to the present invention can be applied to actual industrial environments much better than the conventional arts.

### Experimental Example 17—In situ DRIFTs Analysis

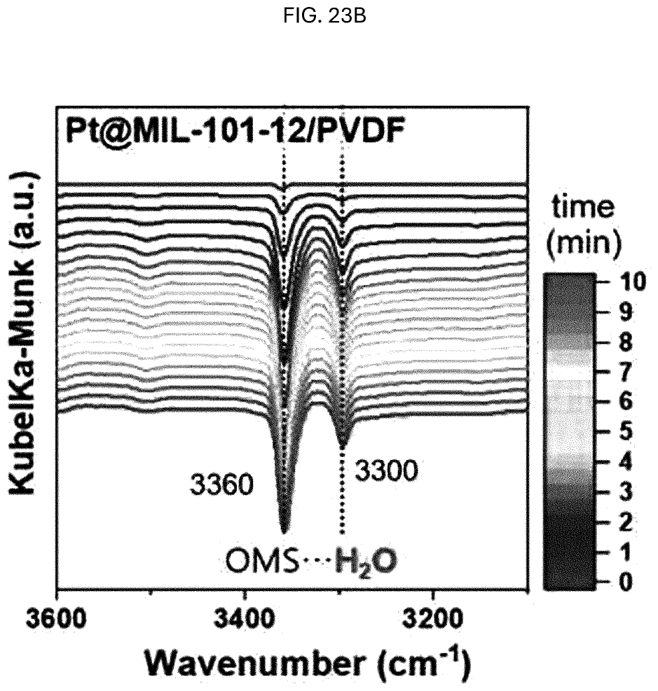

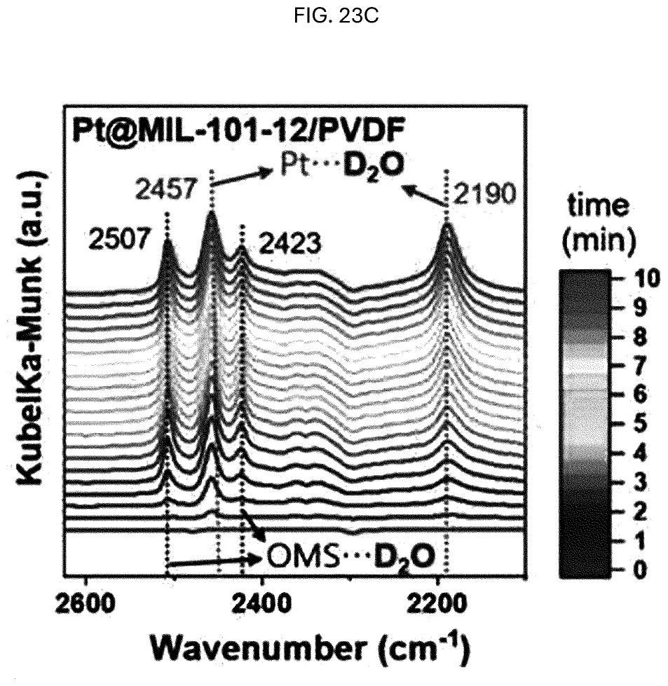

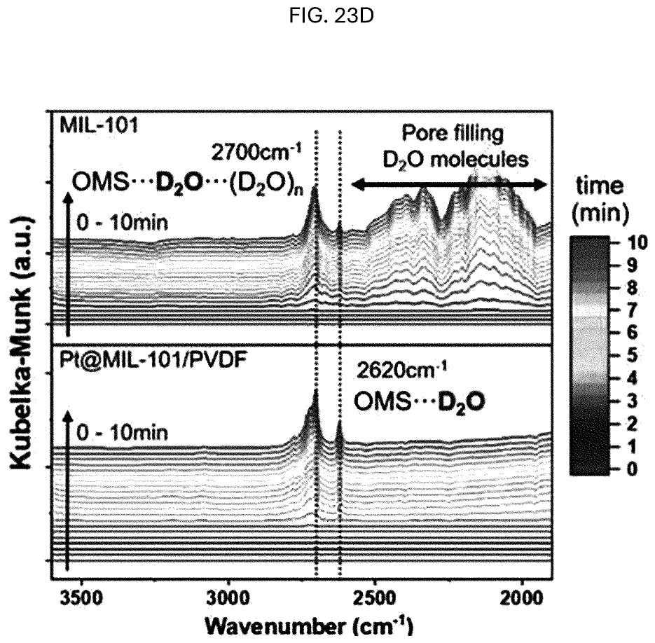

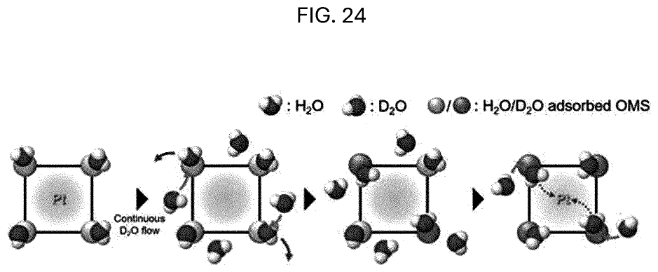

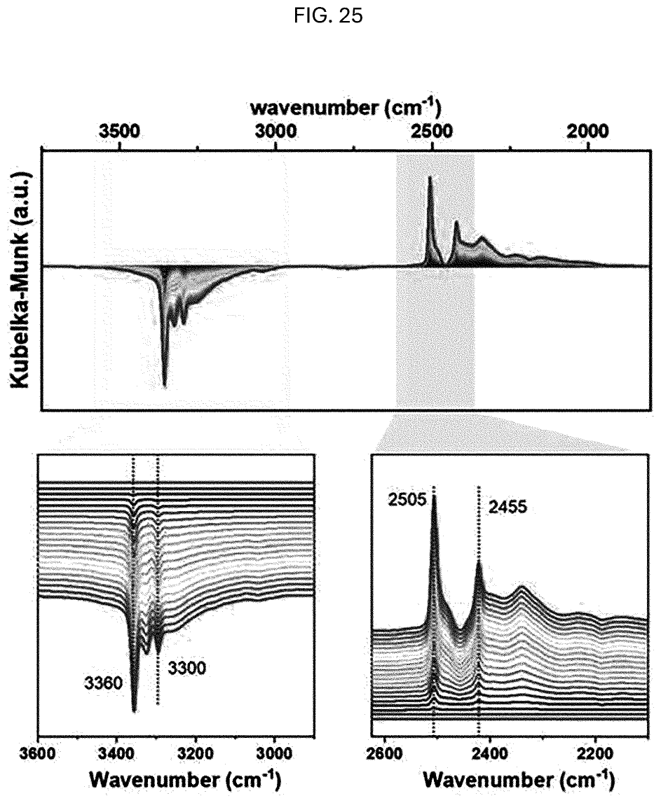

In situ Diffuse Reflectance Infrared Fourier Transform Spectroscopy (In situ DRIFTs) analysis was performed on MIL-101-12/PVDF manufactured by dispersing Example 1, Comparative Example 1, and Comparative Example 2 in PVDF in the same manner as in Example 1, and on Pt@MIL-101/PVDF manufactured by dispersing Comparative Example 3 in PVDF in the same manner as in Example 1. The results of the entire spectrum of Example 1 are shown in FIG. 23A, and the region where the H₂O bond was formed in the spectrum of Example 1 is enlarged and shown in FIG. 23B, and the region where the D₂O bond was formed in the spectrum of Example 1 is enlarged and shown in FIG. 23C, and the results of the spectra of Comparative Example 1 and Pt@MIL-101/PVDF are shown in FIG. 23D. In addition, a schematic diagram of the behavior of H₂O molecules and D₂O molecules for Example 1 is shown in FIG. 24. In addition, the spectrum results of MIL-101-12/PVDF are shown in FIG. 25.

As can be seen in FIGS. 23B and 23C, in Example 1, the peaks at 3300 cm⁻¹ and 3360 cm⁻¹ corresponding to the H₂O adsorption peaks continuously decrease over time, and the peaks at 2423 cm⁻¹ and 2507 cm⁻¹ corresponding to the D₂O adsorption peaks continuously increase.

This is different from FIG. 23D in that such changes are not observed in Comparative Example 1 and Pt@MIL-101/PVDF. This tendency occurs because the H₂O molecules that were adsorbed before the introduction of D₂O in Example 1 are gradually replaced by D₂O. In addition, it can be seen that the fact that this tendency was not observed in Comparative Example 1 and Pt@MIL-101/PVDF is because in both cases, the hydrophobically modified compound was not introduced, so that the water molecules bound to the OMS were not replaced with the surrounding water molecules. This means that in the case of the catalyst composite according to the present invention, when performing the hydrogen isotope exchange reaction, the new OMS is smoothly replaced from the existing water molecules to the new water molecules due to the hydrophobic modification, and this repetition of adsorption and desorption supports that the efficiency of the hydrogen isotope reaction is very excellent. In conclusion, in the case of Example 1, as shown in FIG. 24, the water molecules in the OMS are easily adsorbed and desorbed, so that the reaction efficiency of the hydrogen isotope exchange is excellent.

In addition, as shown in FIG. 23C, it can be seen that the peaks at 2190 cm-1 and 2457 cm-1 are also increasing, which is a peak that was not observed in FIG. 25 and is due to the bonding of platinum and D₂O. Considering that the amount of platinum in Table 2 mentioned above is only trace compared to OMS (the molar ratio of Pt to Cr: 0.019), the peak intensity as in FIG. 23C means that D₂O is adsorbed on platinum very efficiently, which means that D₂O that can participate in the reaction is very abundant in Example 1. In addition, when compared with FIG. 23D, this peak was not observed in Pt@MIL-101/PVDF of FIG. 23D, which means that the contact between platinum and D₂O was significantly increased by the hydrophobic modification of Example 1, which means that Example 1 is very superior in terms of the efficiency of the hydrogen isotope exchange reaction compared to other cases.

### Experimental Example 18—Analysis of Structural Stability in a Radioactive Environment—SEM Analysis

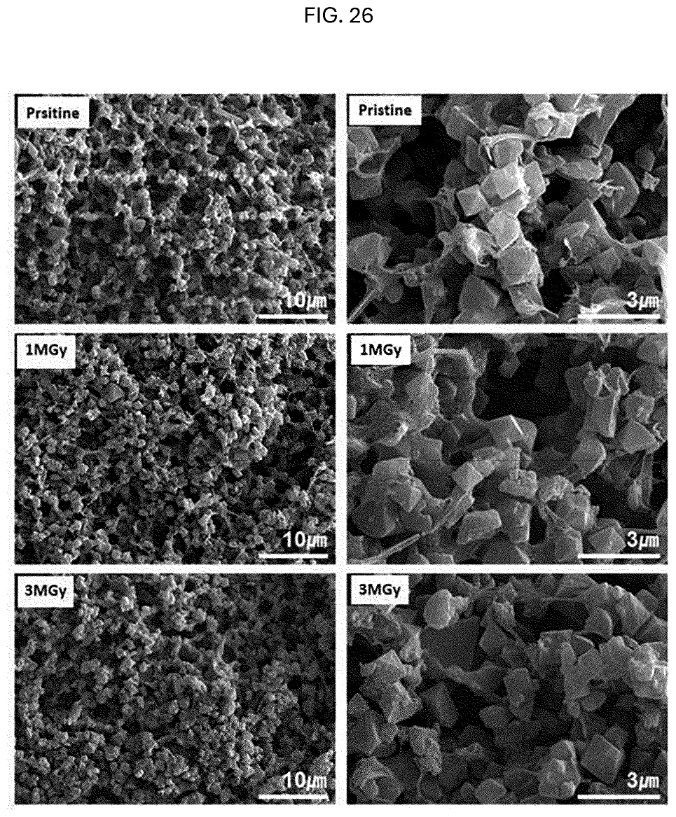

Unlike deuterium, tritium emits radioactivity, so in order to analyze the structural stability in a radioactive environment, Example 1 was irradiated with radiation, and then SEM was taken to analyze the structural stability. At this time, analyses were performed for the cases in which no radiation was irradiated and in which the accumulated radiation dose was 1 MGy and 3 MGy using a film dosimeter (B3000) at room temperature using an electron beam (1.2 MeV, beam current: 15 mA). SEM photographs were taken and are shown in FIG. 26.

As can be seen in FIG. 26, even after exposure to radiation, the integrity of the porous PVDF matrix in Example 1 is maintained, and the Pt@MIL-101-12 dispersed inside has an octahedral crystal form, confirming that the structural stability is maintained even in a radioactive environment. This means that the catalyst composite according to the present invention can operate even in an environment where tritium exists, and can exhibit excellent reaction efficiency even when the hydrogen isotope is tritium in the hydrogen isotope exchange reaction.

### Experimental Example 19—Analysis of Structural Stability in a Radioactive Environment—FT-IR Analysis

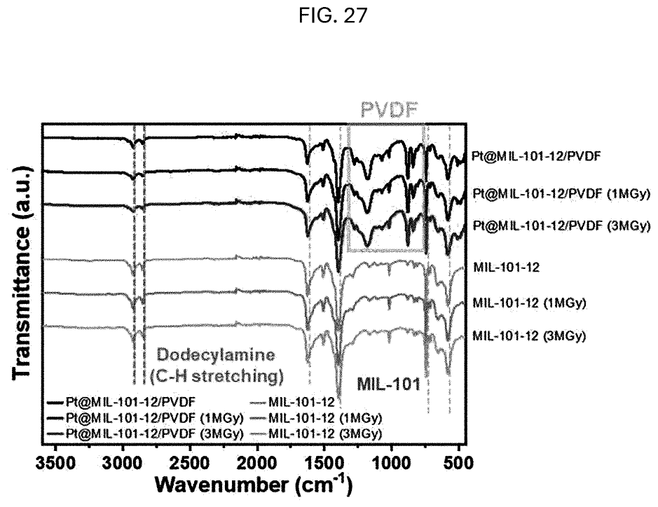

Example 1 and Comparative Example 2 were irradiated with radiation in the same manner as Experimental Example 18, and FT-IR analysis was performed, and the results are shown in FIG. 27.

As can be seen in FIG. 27, both Example 1 and Comparative Example 2 observed peaks corresponding to 500-1700 cm⁻¹ before and after radiation exposure, and the peaks at 2960 cm⁻¹ and 2850 cm⁻¹ resulting from the C—H elongation of dodecylamine were also maintained. In addition, peaks at about 1170, 1070, 880 and 840 cm⁻¹ related to the C—H and C—C bonds of PVDF were also observed both before and after radiation exposure. This means that both Example 1 and Comparative Example 2 maintained stability in their chemical bonds despite radiation exposure. This means that the catalyst composite according to the present invention can operate even in an environment where tritium is present, and can exhibit excellent reaction efficiency even when the hydrogen isotope is tritium in the hydrogen isotope exchange reaction.

### Experimental Example 20—Analysis of Structural Stability in a Radioactive Environment—XRD Analysis

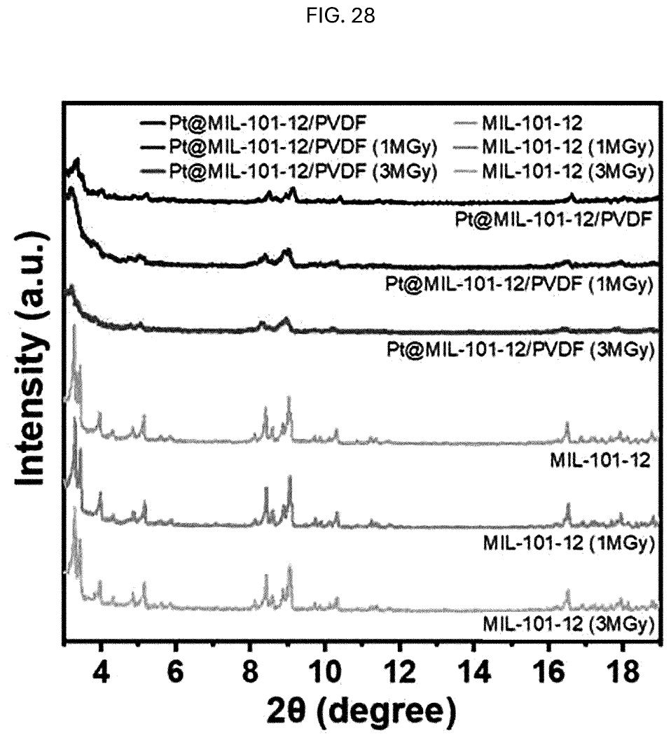

Example 1 and Comparative Example 2 were irradiated with radiation in the same manner as Experimental Example 18, and then XRD analysis was performed, and the results are shown in FIG. 28.

As can be seen in FIG. 28, the XRD patterns are the same before and after irradiating radiation in Example 1 and Comparative Example 2, which means that the crystal structure is stably maintained even though the radiation was irradiated in both Example 1 and Example 2. This means that the catalyst composite according to the present invention can operate even in an environment where tritium exists, and can exhibit excellent reaction efficiency even when the hydrogen isotope is tritium in the hydrogen isotope exchange reaction.

### Experimental Example 21—Analysis of Structural Stability in a Radioactive Environment—XPS Analysis

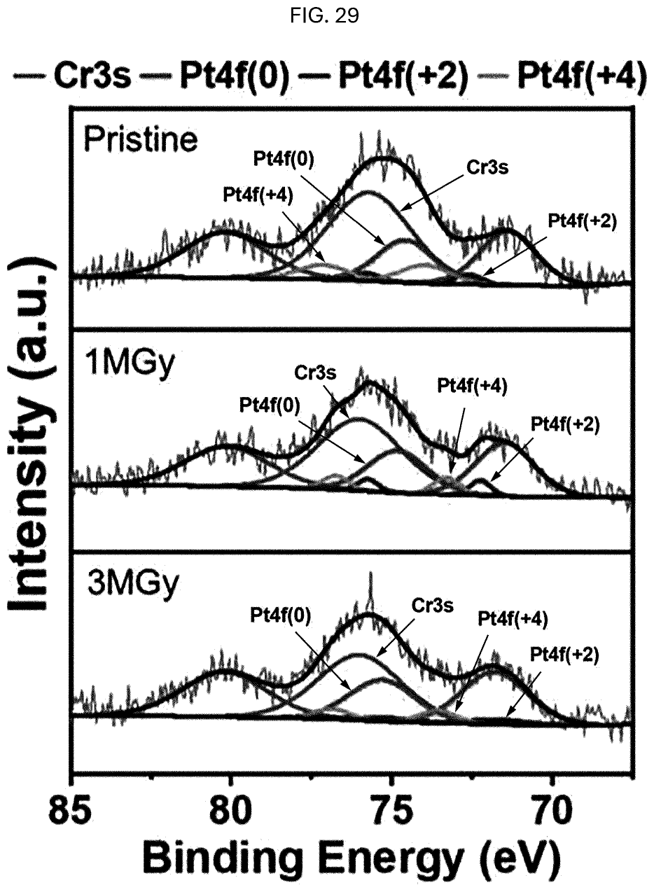

Example 1 and Comparative Example 2 were irradiated with radiation in the same manner as Experimental Example 18, and then XPS analysis was performed, and the results are shown in FIG. 29.

As can be seen in FIG. 29, it can be confirmed that the spectrum of Pt4f does not change in the XPS spectra of both Example 1 and Comparative Example 2 before and after irradiation with radiation. This means that the oxidation state of Pt used as a catalyst does not change even after irradiation with radiation, and that Pt still maintains a state of having catalytic activity even after irradiation. This means that the catalyst composite according to the present invention can operate even in an environment where tritium is present, and can exhibit excellent reaction efficiency even when the hydrogen isotope is tritium in the hydrogen isotope exchange reaction.

What is claimed is:

1. A catalyst composite for exchanging hydrogen isotope, the catalyst composite comprising:
a catalyst support including a metal organic framework complex having an open metal site (OMS) and pores;
a hydrophobically modified compound introduced into the OMS; and
a metal catalyst configured to exchange hydrogen isotope, the metal catalyst being introduced into the pores.

2. The catalyst composite of claim 1, further comprising:
a catalyst matrix,
wherein the catalyst support is dispersed within the catalyst matrix.

3. The catalyst composite of claim 1,
wherein the water contact angle of the metal organic framework complex is 90° or more.

4. The catalyst composite of claim 1,
wherein the water contact angle of the metal organic framework is 90° or more, and a water vapor diffusivity is 5×10⁻¹⁴ cm²/s or more.

5. The catalyst composite of claim 1,
wherein the hydrophobically modified compound includes a compound represented by Chemical Formula 1 below: 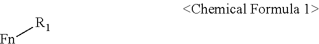
Fn includes any one of —NH₂, —NH—, —NRH, —N═, —NR₂, —C₅H₅N, —OH, —COOH, —PH₂, —PO₃²— or —SH,
R₁ includes any one of a C1 to C20 alkyl group, a C1 to C20 heteroalkyl group, C1 to C20 aryl group or a C1 to C20 heteroaryl group.

6. The catalyst composite of claim 1,
wherein the hydrophobically modified compound includes at least one selected from the group consisting of dodecylamine, decylamine, octylamine, hexylamine, aniline and benzylamine.

7. The catalyst composite of claim 1,
wherein the metal catalyst includes at least one selected from the group consisting of Pt, Pd, Ir, Rh, Re, Ni, Co, W, Cu, Au, Ag, Mo and Fe.

8. The catalyst composite of claim 2,
wherein the catalyst matrix includes a hydrophobic polymer matrix.

9. The catalyst composite of claim 1, further comprising:
a binder,
wherein the catalyst support is aggregated by the binder.

10. A method for manufacturing a catalyst composite for exchanging hydrogen isotope, the method comprising:
preparing a metal organic framework including an open metal site (OMS) and pores;
forming a hydrophobically modified metal organic framework complex by introducing a hydrophobically modified compound into the OMS of the metal organic framework;
reacting the hydrophobically modified metal organic framework complex with a catalyst matrix to disperse inside the catalyst matrix, and
introducing a metal catalyst for hydrogen isotope exchange between the preparing and the forming, or between the forming and reacting.

11. The method of claim 10,
wherein the water contact angle of the hydrophobically modified metal organic framework complex is 90° or more.

12. The method of claim 10,
wherein the hydrophobically modified compound includes a compound represented by Chemical Formula 1 below: 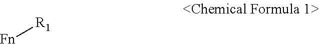
Fn includes any one of —NH₂, —NH—, —NRH, —N═, —NR₂, —C₅H₅N, —OH, —COOH, —PH₂, —PO₃²— or —SH,
R₁ includes any one of a C1 to C20 alkyl group, a C1 to C20 heteroalkyl group, C1 to C20 aryl group or a C1 to C20 heteroaryl group.

13. A catalyst composite for exchanging hydrogen isotope produced by the method according to claim 10.
